(19) United States
(12) Patent Application Publication
(10) Pub. No.: US 2005/0038733 A1
(43) Pub. Date: Feb. 17, 2005

(54) Seller configurable merchandising in an electronic marketplace

(76) Inventors: Benjamin David Foster, San Jose, CA (US); Andrew Leigh Sandler, San Jose, CA (US); Anne Chang Raimondi, San Jose, CA (US); Meredith Elizabeth Mortimer, San Carlos, CA (US); Tia Diann Yansen, Portola Valley, CA (US); Michael Charles Dearing, Santa Clara, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/944,070

(22) Filed: Sep. 17, 2004

Related U.S. Application Data
(63) Continuation of application No. PCT/US03/22757, filed on Jul. 21, 2003.

(51) Int. Cl. G06F 17/60

(52) U.S. Cl. 705/37; 705/30

(57) ABSTRACT

A method and a system for merchandising in a network-based marketplace. Sellers enter item information that identifies items to be transacted in a network-based marketplace. Sellers also identify referring items and promoted items and generate associations between them. In response to a buyer's request for the item information on a referring item, the network-based marketplace presents the item information for promoted items in addition to the item information for the referring item.

### RELATED APPLICATIONS

This application is a continuation of International Application No. PCT/US2003/022757, filed Jul. 21, 2003, which claims the benefit of the filing date of U.S. utility patent application no. 10,200,908, filed Jul. 22, 2002, now abandoned. The above-mentioned applications are hereby incorporated by reference.

### FIELD OF THE INVENTION

The present invention relates generally to the field of electronic commerce and, more specifically, to a method and system for facilitating merchandising in an electronic marketplace.

### BACKGROUND INFORMATION

Network-based commerce has increased tremendously. This increase has been attributed to buyers and sellers who have overcome initial hesitations to electronically transact merchandise. In addition, electronic market makers may also be responsible because some are beginning to provide enhanced retail techniques, such as merchandising.

Merchandizing is used to increase sales. Merchandising exploits a buyer's interest in one item to promote the sale of another item. Nevertheless, marketplaces that electronically enable merchandising, differ considerably.

Electronic marketplaces differ in the degree and type of control they offer sellers. Many network-based marketplaces do not permit the seller to determine the items promoted to a potential buyer. For instance, some systems detect a buyer's interest in one item and automatically promote a similar item that is offered by the same seller. Other systems monitor a buyer's behavior and promote an item based upon those behaviors. In both cases, the system selects the promoted item and not the seller. Further, some systems provide network-based seller configurable merchandising.

### SUMMARY OF INVENTION

A method, to facilitate merchandising in a network-based marketplace, includes receiving item listings at the network-based marketplace from a plurality of sellers, each item listing including the item information identifying an item to be transacted via the network-based marketplace. Association information is received at the network-based marketplace from a first seller of the plurality of sellers indicating a merchandising association between a first item and a second item, the first and second items each being associated with the first seller. Responsive to an access request, received at the network-based marketplace from a potential buyer, for the item information identifying the first item, the item information is presented for the first item and the second item. The second item is identified using the association information. The item information identifying the second item is presented for the purpose of merchandising the second item.

A method, to facilitate the collection of merchandising information for a network-based marketplace, includes at a seller computer, receiving item listings, each item listing including the item information identifying an item to be transacted via the network-based marketplace. At the seller computer, association information is received indicating a merchandising association between a first item and a second item, the first and second items each being associated with a seller. At the seller computer, the association information is stored indicating the merchandising association in a batch file. At the seller computer, the batch file is transmitted to an application program interface at the network-based marketplace so as to enable the network-based marketplace to store the merchandising association between the first and second items.

A method to automatically create merchandising associations between items includes examining a first merchandising association defined by a first user of a network-based marketplace and inferring a second merchandising association to be applied to items for sale by a second user based on the first merchandising association.

### BRIEF DESCRIPTION OF THE DRAWINGS

The present invention is illustrated by way of example and not limitation in the figures of the accompanying drawings, in which like references indicate similar elements and in which:

FIG. 1 is a block diagram illustrating an exemplary network-based marketplace, sellers and buyers.

FIG. 2 is a block diagram illustrating software and hardware components utilized by an exemplary network-based marketplace, sellers and buyers.

FIG. 2A is a block diagram illustrating an exemplary client application program.

FIG. 3 is a block diagram illustrating an exemplary application program interface utilized for receiving a batch file.

FIG. 4 is a block diagram illustrating a merchandising module utilized for receiving exemplary association information by the network-based marketplace.

FIG. 5 is a block diagram illustrating a listing module utilized for presenting exemplary association information and exemplary listing information.

FIG. 6 is a database diagram illustrating an exemplary database maintained and accessed via a database engine server that supports the network-based marketplace.

FIG. 7 illustrates an exemplary embodiment of an item association table within a database maintained by the exemplary network-based marketplace.

FIG. 8 illustrates an exemplary embodiment of a user table within a database maintained by the exemplary network-based marketplace.

FIG. 9 illustrates an exemplary embodiment of a price range type association table within a database maintained by the exemplary network-based marketplace.

FIG. 10 illustrates an exemplary embodiment of a category type association table within a database maintained by the exemplary network-based marketplace.

FIG. 11 illustrates an exemplary embodiment of a sales-format type association table within a database maintained by the exemplary network-based marketplace.

FIG. 12 illustrates an exemplary embodiment of a Keyword Type Association Table within a database maintained by the exemplary network-based marketplace.

FIG. 13 is a flow chart illustrating a method, according to an exemplary embodiment of the present invention, to facilitate merchandising in a network-based marketplace.

FIG. 14 is a flow chart illustrating an exemplary identification of promoted items via a referring item.

FIG. 15 is a flow chart illustrating a method 310 according to an exemplary embodiment of the present invention to identify a promoted item based on a computed promotion type.

FIG. 16 is a flow chart illustrating a method, according to an exemplary embodiment of the present invention, for collecting merchandising information for a network-based marketplace.

FIG. 17 illustrates an exemplary merchandising associations page.

FIGS. 18-20 illustrate exemplary pages used for viewing, creating and confirming merchandising associations between items.

FIGS. 21-26 illustrate exemplary pages used for creating and editing merchandising association types.

FIG. 27 illustrates an exemplary embodiment of a presentation of merchandised items.

FIG. 28 shows a diagrammatic representation of an exemplary machine.

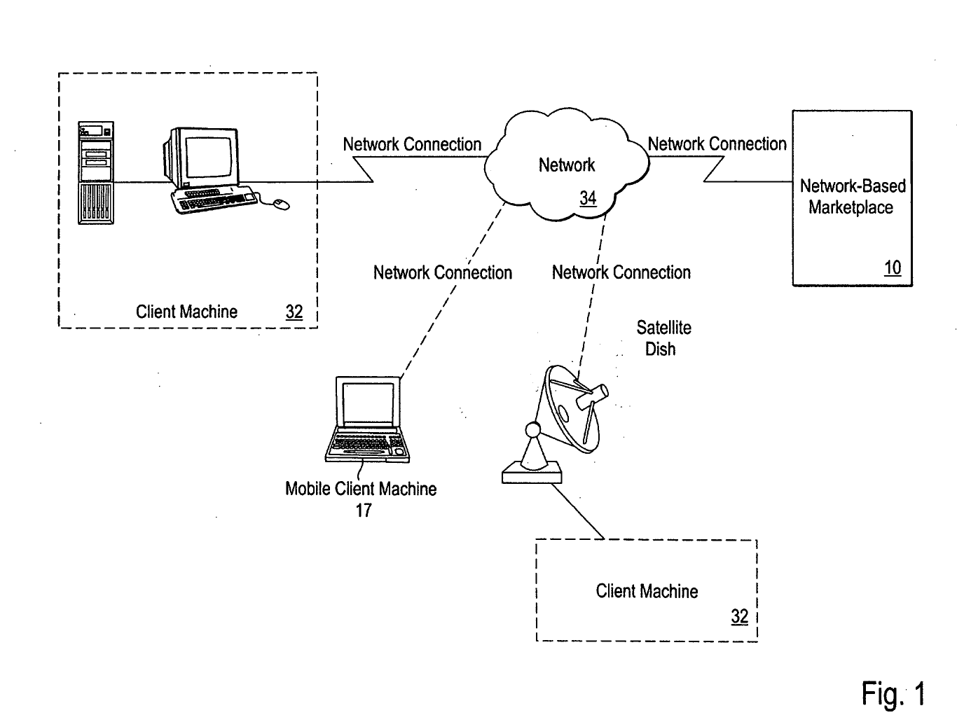

### DETAILED DESCRIPTION

A method and system to facilitate merchandising in an network-based marketplace is described. In the following description, for purposes of explanation, numerous specific details are set forth in order to provide a thorough understanding of the present invention. It will be evident, however, to one skilled in the art that the present invention may be practiced without these specific details.

In general, embodiments described below feature a network-based marketplace that allows users of the marketplace to transact items (e.g., products or services) that are offered for sale by sellers. Further, the network-based marketplace allows a user to view advertisements on items that are transacted outside the electronic marketplace. One embodiment of the present invention features an application to facilitate transacting utilizing a marketplace.

In one embodiment, the present invention is implemented as a network-based service that may be accessed through, for example, the Internet using a Web browser. According to one aspect of the present invention, the service provides an interface that allows a seller to list items for transaction and form merchandising associations between those items. A buyer that requests the item information for a referring item is presented the item information for associated promoted items in addition to the requested information. According to another aspect of the present invention, the service provides a client-based mechanism to efficiently collect merchandising associations. According to a further aspect of the present invention, the service computes a merchandising association based upon the most commonly configured seller merchandising associations.

Hardware and Software Components

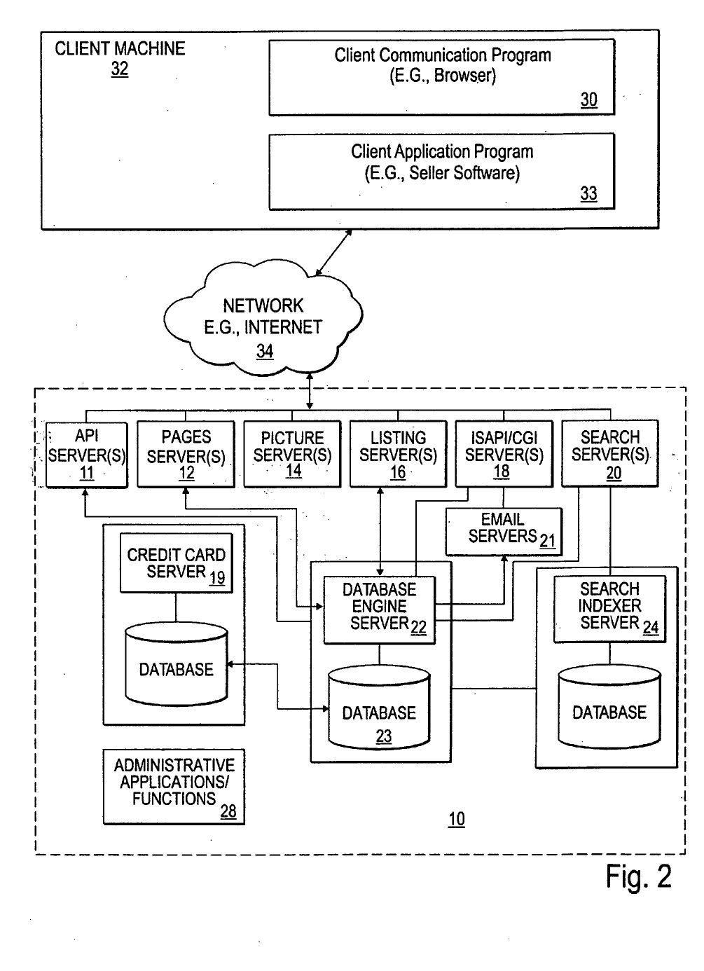

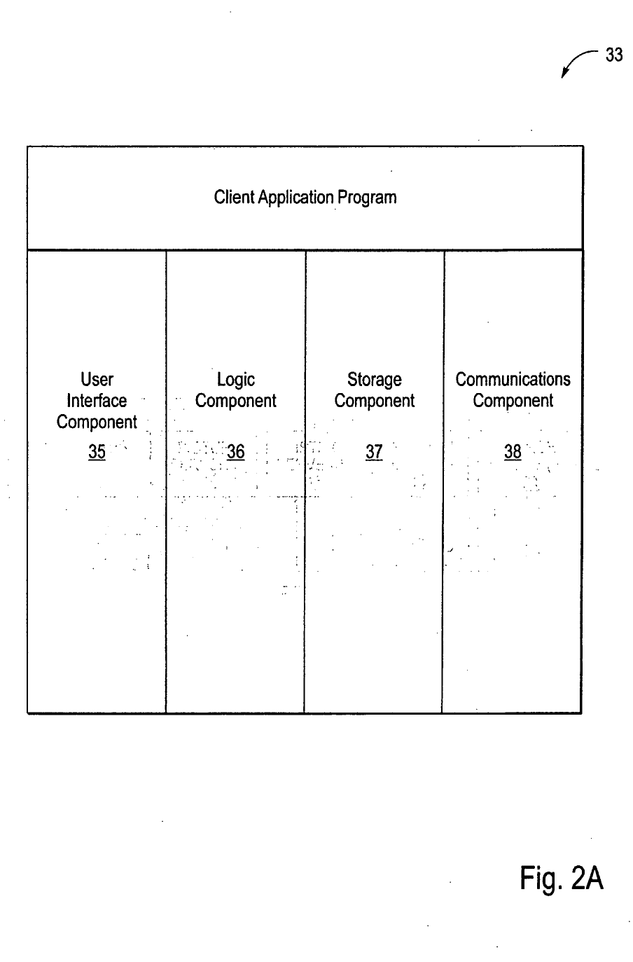

FIG. 2 is a block diagram illustrating software and hardware components utilized by the exemplary network-based marketplace 10, seller and potential buyer, according to an exemplary embodiment of the present invention.

In addition to other software components that are not illustrated, the client machine 32 includes a client communication program 30 and a client application program 33. The client communication program 30 enables a user to display web pages or email that are loaded from server computers. The client communication program 30 may be embodied as a browser (e.g., the Microsoft Internet Explorer browser developed by Microsoft™ Corporation of Richmond, Wash. or Navigator™ browser developed by Netscape of Mountain View, Calif.). The client communication program 30 executes under an operating system (e.g., Microsoft™ Windows developed by Microsoft™ Corporation or Mac OS X developed by Apple Computers of Cupertino, Calif.). The client communication program 30 may also be embodied as a mail client (e.g., the Microsoft Outlook personal information manager developed by Microsoft™ Corporation of Richmond, Wash. or Lotus Notes™ developed by the Lotus Notes Development Corporation.

A client application program 33, according to an exemplary embodiment of the present invention, is also show in FIG. 2 to be hosted on the client machine 32 and enables a seller to enter (or input) the item information and association information while not connected to a network 34. Thus, a seller may use the client application program 33 to create, edit and delete, for example, item-to-item merchandising associations and type-to-type merchandising associations at the client machine 32. The client application program 33 stores the item information and the association information in a batch file and subsequently communicates the batch file to an application program interface module 171.

Again referring to FIG. 2, the network-based marketplace 10 includes one or more of a number of types of front-end servers, namely communications servers in the exemplary form of an application program interface (API) servers 11, page servers 12 that deliver web pages (e.g., markup language documents), picture servers 14 that dynamically deliver images to be displayed within Web pages, listing servers 16, processing servers in the exemplary form of CGI (or ISAPI) servers 18 that provide an intelligent interface to back-end servers, and search servers 20 that handle search requests to the marketplace 10. The e-mail servers 21 provide, inter alia, automated e-mail communications to users of the network-based marketplace 10.

The back-end servers include a database engine server 22, a search index server 24 and a credit card database server 26, each of which maintains and facilitates access to a respective database.

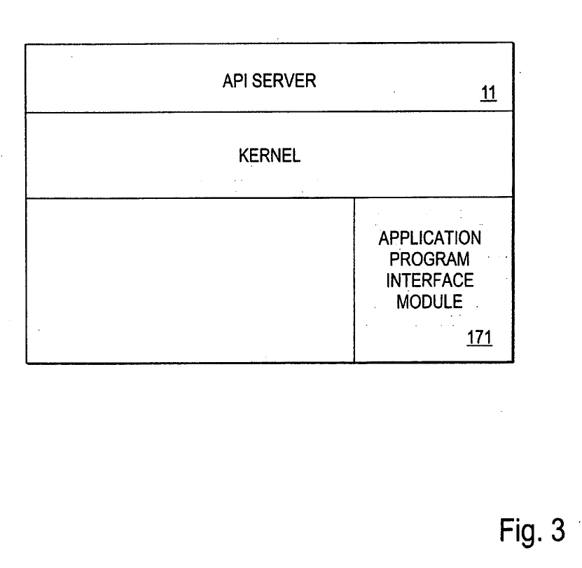

FIG. 3 is a block diagram illustrating an exemplary application program interface in the form of application program interface module (APIM) 171. The APIM 171 executes on an API server 11 and under kernel operating software to receive batch files of the item information and the association information from the client application program 33. Further, the APIM 171 ensures that the items table 42 and the item association table 43 are respectively updated with item and association information.

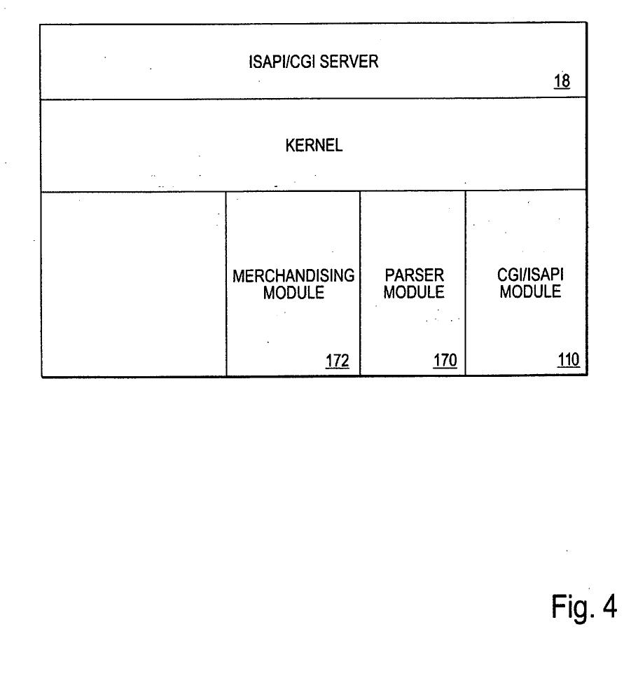

FIG. 4 is a block diagram illustrating a merchandising module 172, according to an exemplary embodiment of the present invention, utilized for receiving the association information by the network-based marketplace 10. The merchandising module 172, a parser module 170 and an CGI/ISAPI Module 110 operate under the control of kernel system software on the ISAPI/CGI Server 18. Further, the merchandising module 172, the parser module 170 and the CGI/ISAPI Module 110 operate concurrently to facilitate the configuration of the merchandising associations in the network-based marketplace 10.

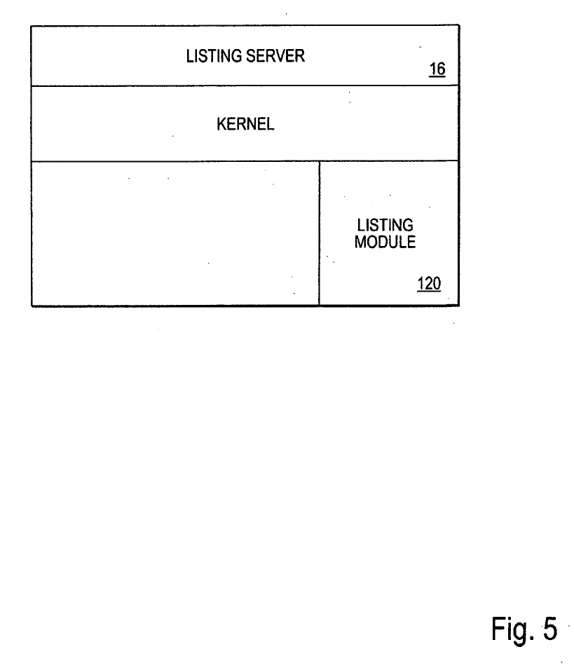

FIG. 5 is a block diagram illustrating a listing module 120, according to an exemplary embodiment of the present invention, utilized for presenting the association information and the listing information. The listing module 120 operates under the control of kernel system software on the listing server 16. In addition, the listing module 120 includes an examination module and an inferring module for automatically creating or computing merchandising associations between items. The examination module examines merchandising associations defined by users in the network-based marketplace. The merchandising associations include item-to-item associations, type-to-type associations, type-to-item associations, item-to-type associations, etc. The examination module examines all merchandising associations for the purpose of identifying a merchandising association with referring information that matches an item offered for transaction by a seller. An inferring module utilizes the identified merchandising associations to infer or compute a merchandising association that is applied to other items offered for sale by the same seller. The inferring module applies the merchandising association to identify items for promotion.

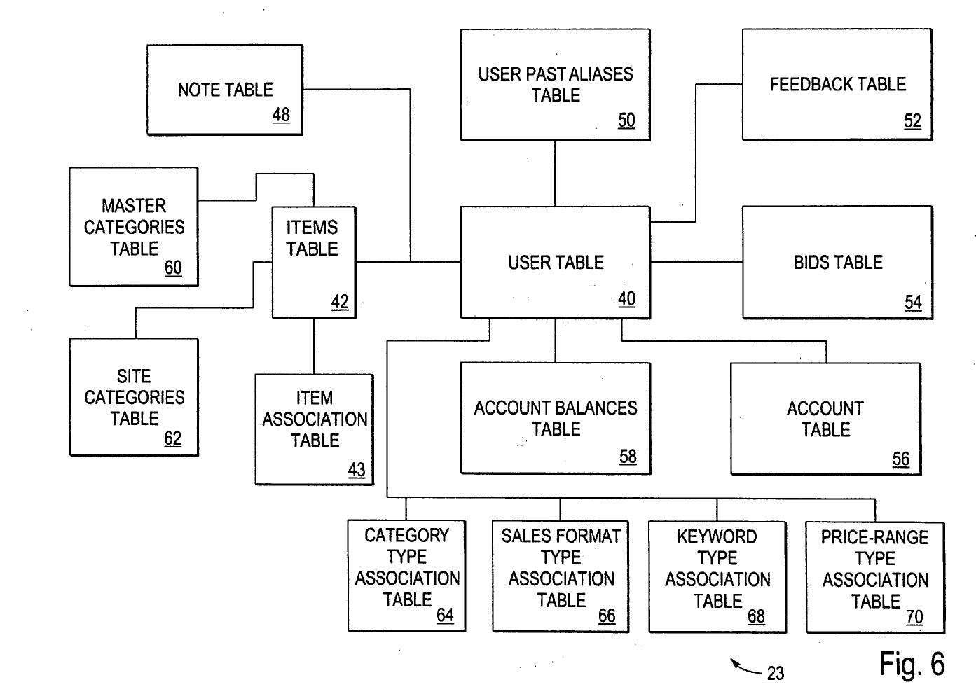

FIG. 6 is a database diagram illustrating an exemplary database 23 maintained and accessed via a database engine server 22 that supports the network-based marketplace 10. The database 23 may, in one embodiment, be implemented as a relational database, and includes a number of tables having entries, or records, that are linked by indices and keys. In an alternative embodiment, the database 23 may be implemented as collection of objects in an object-oriented database.

The database 23 includes a user table 40, which contains a record for each user of the network-based marketplace 10. A user may operate as a seller, buyer, or both, within the network-based marketplace 10. The database 23 also includes an items table 42 that may be linked to the user table 40 and an item association table 43. A user record in the user table 40 may be linked to multiple items that are being, or have been, transacted via the network-based marketplace 10.

The database 23 also include a note table 48 populated with note records that may be linked to one or more item records within the items table 42 and/or to one or more user records within the user table 40. Each note record within the table 48 may include, inter alia, a comment, description, history or other information pertaining to an item being auction via the network-based marketplace 10, or to a user of the network-based marketplace 10.

A number of other tables are also shown to be linked to the user table 40, namely a user past aliases table 50, a feedback table 52, a feedback details table 53, a bids table 54, an accounts table 56, and an account balances table 58.

A master categories table 60 stores records for item categories presented across multiple views (or presentations) of item categories via regional or community sites presented by the network-based marketplace 10. A site categories table 62 stores records indicating which item categories are to be presented for respective regional or community sites, (e.g., a country, region or city specific site) presented by the network-based marketplace 10.

The database 23 is also shown to include five tables specifically to enable an exemplary embodiment of the present invention. The item association table 43 stores records for item-to-item merchandising associations. Further, the item association table 43 includes records that link to items in the items table 42. Further, four exemplary type association tables include a category type association table 64, a sales-format type association table 66, a keyword type association table 68 and a price-range association table 70. The type association tables store the merchandising associations between items that are established by an item type (e.g. category, sales-format, etc.).

Tables

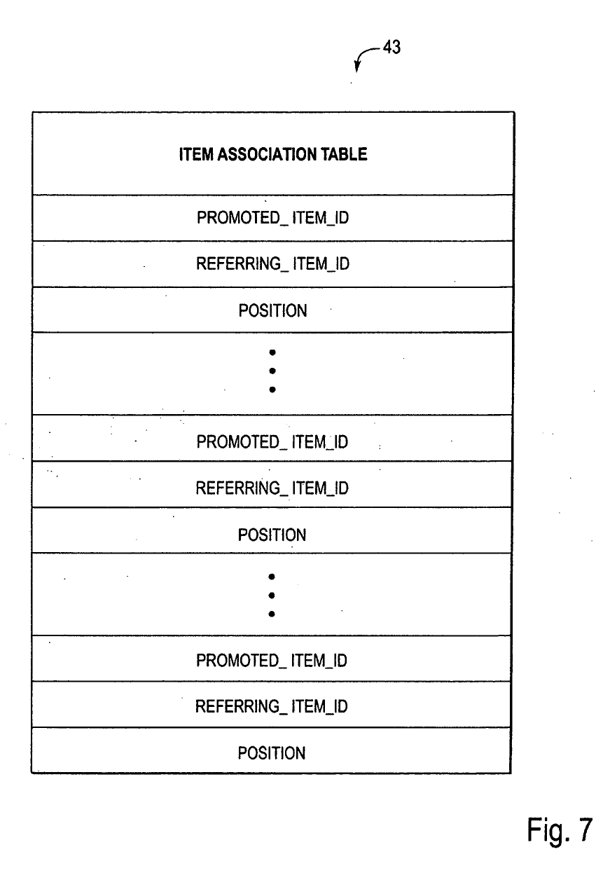

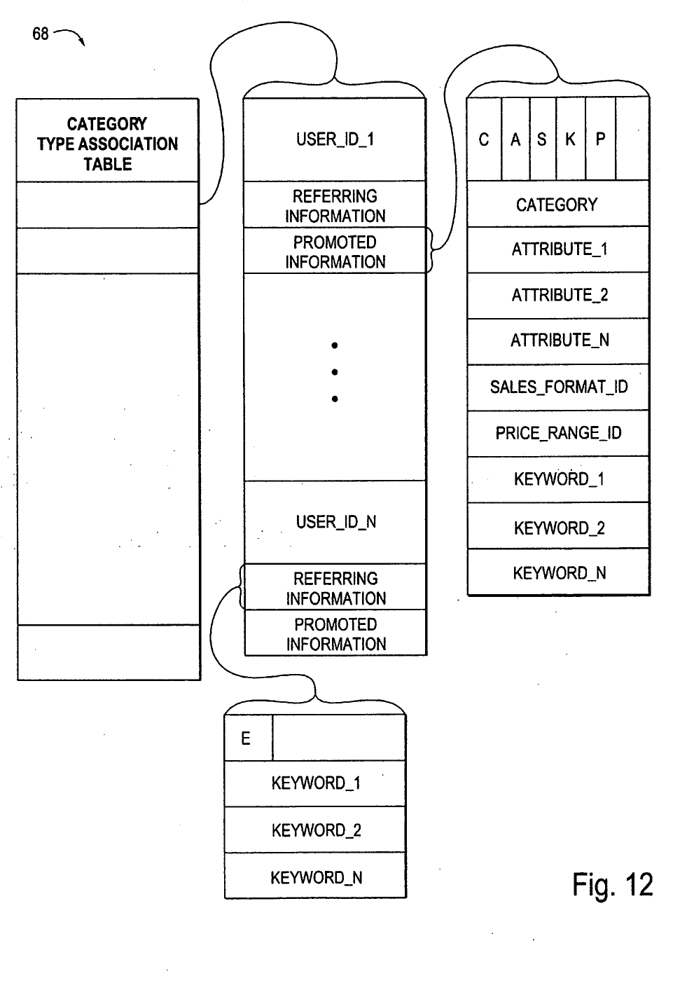

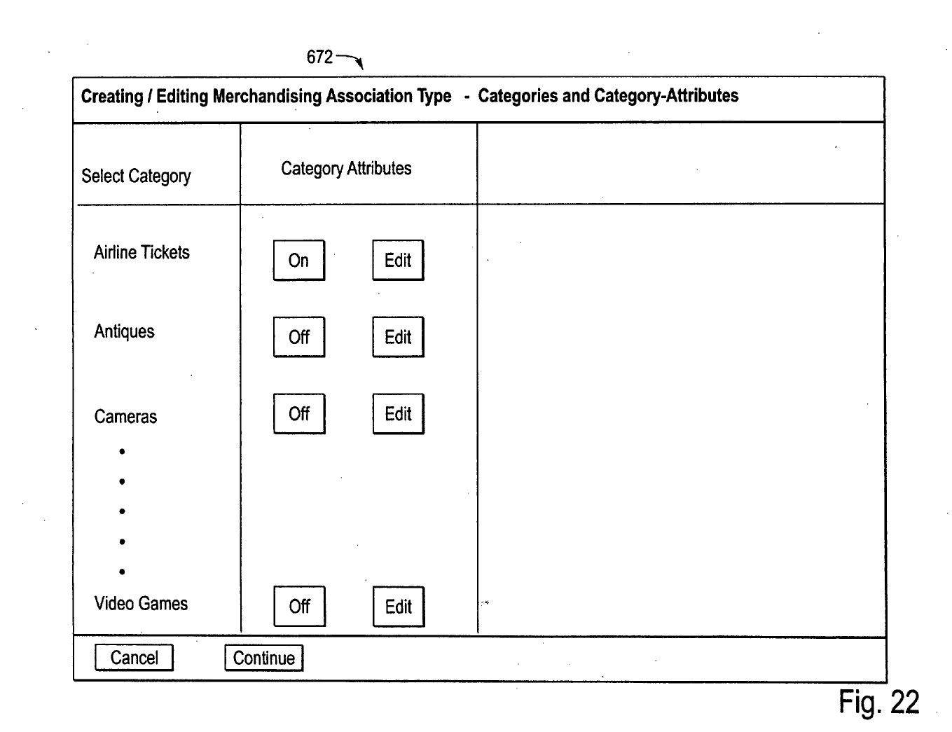

FIG. 7 illustrates an exemplary embodiment of an item association table 43 within a database 23 maintained by the network-based marketplace 10. The item association table 43 includes promoted_item_id, referring_item_id and position fields for each referring item in the network-based marketplace 10. The promoted_item_id field and the referring_item_id field both hold item identification numbers that identify the items for which the records are stored in the items table 42. An item identification number may be used to obtain listing information for the respective items. The position field may hold a value to indicate a merchandising position of the promoted item on a page. The position may, for example, be spot 1, spot 2 or spot 3 (see e.g., FIG. 22). In addition, the position field may also indicate that the promoted item is an alternate. An “alternate” promoted item replaces a “spot” promoted item that is no longer available for merchandising (e.g., the item has been bought or is not longer for sale). Alternates may be prioritized with respect to the order in which they are utilized for replacing spot promoted items. Spot and alternate promoted items may be configured from a creating merchandising association page (FIG. 12).

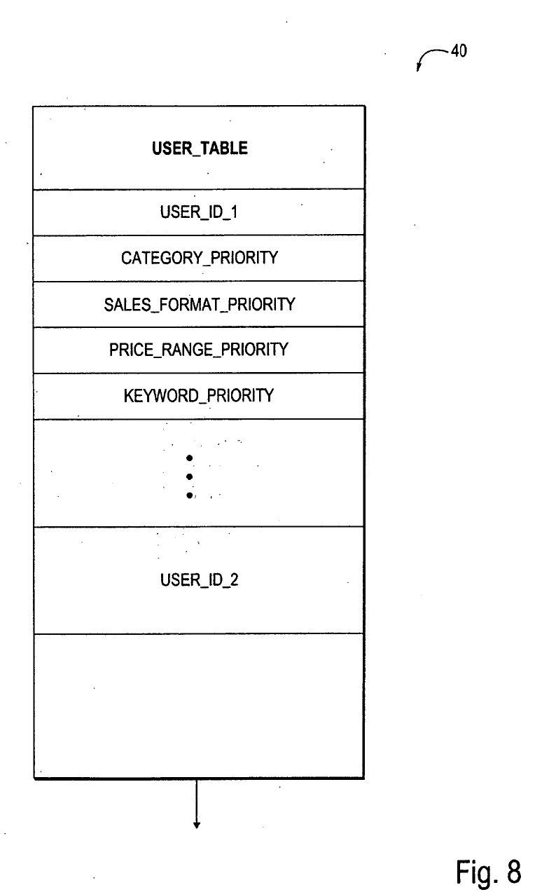

FIG. 8 illustrates selected fields within an exemplary embodiment of the user table 40 within the database 23 maintained by the network-based marketplace 10. The user table 40 is indexed by User_Id, a unique number that is assigned to every user of the network-based marketplace 10. For each user the following fields may be referenced: category priority, sales-format priority, price-range priority and keyword priority. These fields store seller-configured priority values for each of the mentioned item types.

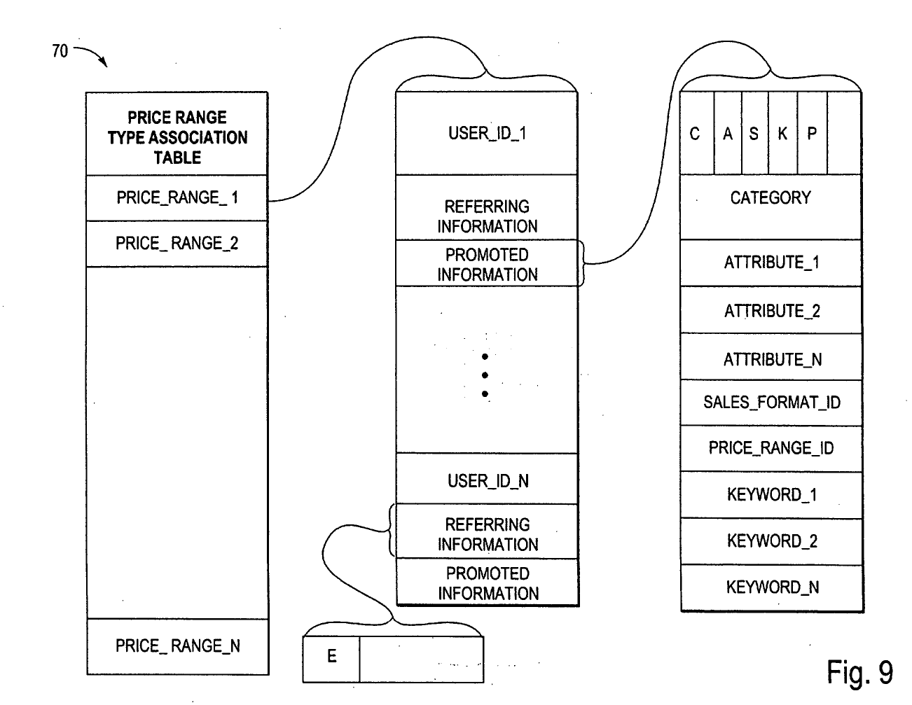

FIG. 9 illustrates a price-range type association table (PRTA) 70, according to an exemplary embodiment of the present invention. The PRTA table 70 is indexed by a referring item's price range (PRICE_RANGE_{—}1, etc.) and seller identification (USER_ID_{—}1, etc.). For instance the price of a referring item may fall within price_range_{—}1 ($1 to $5) or price_range_{—}2 ($5 to $10) etc. The seller configures the PRTA table 70 by providing referring and promoted information.

Referring information includes an enable “E” flag. An asserted “E” flag indicates an enabled price range. A referring item, as selected by a potential buyer, that is included in an enabled price range, triggers a search for other items offered for transaction by the same seller that match a type, as specified in the promoted information fields.

The promoted information includes the following fields: a set of binary flags, category, attributes (attribute_{—}1, attribute_{—}2, etc.), sales_format_id, price_range_id and keywords (keyword_{—}1, keyword_{—}2, etc.). Binary flags are mutually exclusive and indicate an enabled promoted item type. It will be appreciated that other types may be added that typify any characteristic, specification, or detail that is common to items offered for transaction on the network-based marketplace (e.g., availability of gift wrapping, sellers profile information, color of item, region offered for transacting, shipping locations, title of item, etc.). Specific flags are defined as follows: an asserted “c” flag indicates the category type as specified by the category field; an asserted “a” flag indicates the category type as specified by the category field and the attribute types as specified by the attribute_{—}1 attribute_{—}2 etc. fields; an asserted “s” flag indicates a sales-format type as specified by the sales_format_id field; an asserted “k” flag indicates a keyword type as specified by the keyword_{—}1, keyword_{—}2 and keyword_N fields and an asserted “p” flag indicates a price range type as specified by the field.

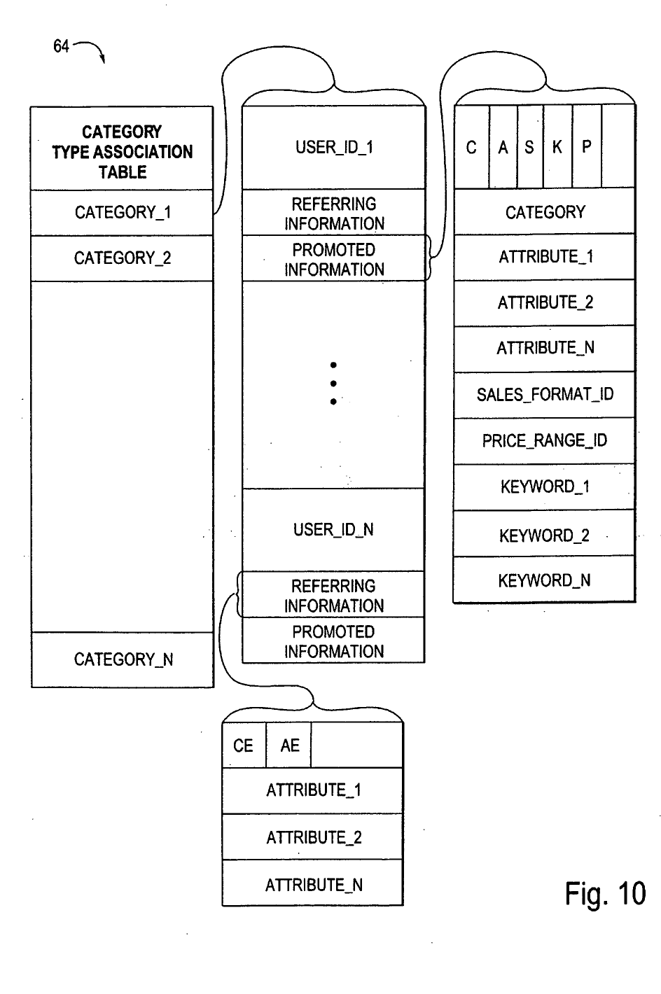

FIG. 10 illustrates a category type association (CTA) table 64, according to an exemplary embodiment of the present invention. The CTA table 64 is indexed by a referring item's category (CATEGORY_{—}1, etc.) and seller identification (USER_ID_{—}1, etc.). For instance, the category of a referring item may be “event ticket” or “toy”. The seller configures the CTA table 64 by providing referring and promoted information.

Referring information includes a “CE” flag, an “AE” flag, attribute_{—}1 attribute_{—}2 etc. An asserted “CE” flag indicates an enabled category. An asserted “AE” flag indicates enabled attributes. The attribute type is optional and further limits the category type. A referring item, as selected by a potential buyer, that is included in the enabled category type, triggers a search for promoted items that match a type, as specified in the promoted information fields. Enabled attributes would additionally require matching attributes before triggering a search. Promoted information fields are defined above.

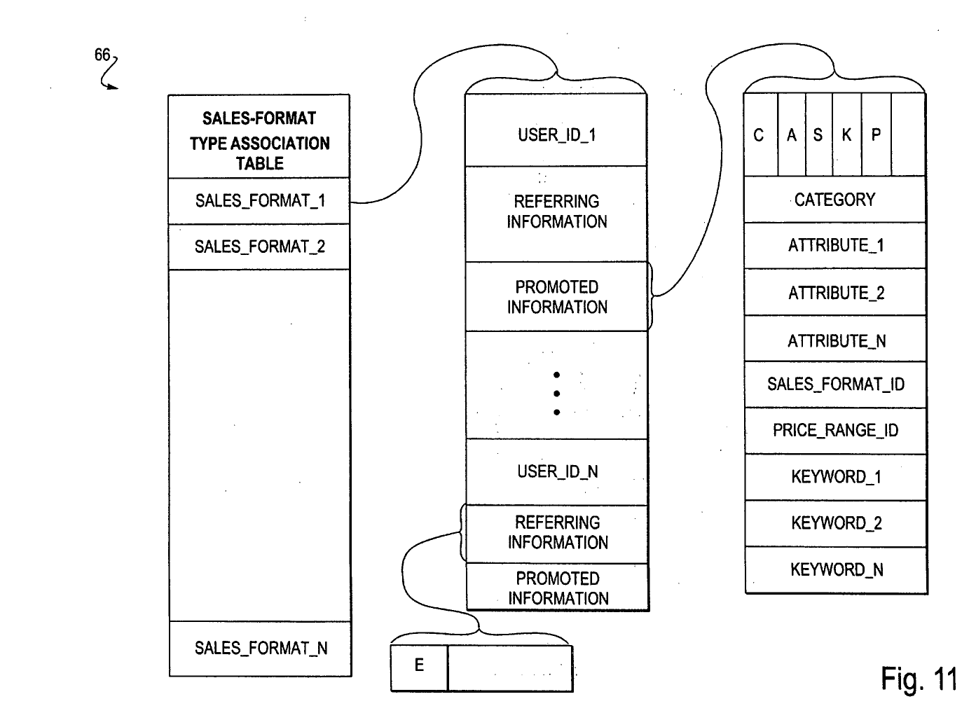

FIG. 11 illustrates a sales-format type association (SFTA) table 66. The SFTA table 66 is indexed by a referring item's sales-format (SALES_FORMAT_{—}1, etc.) and seller identification (USER_ID_{—}1, etc). For instance the sales-format of a referring item may be “auction” or “fixed-price”. The seller configures a sales-format type merchandising association by providing referring and promoted information.

Referring information includes an enable “E” flag. An asserted “E” flag indicates an enabled sales-format type. A referring item, as selected by a potential buyer, that is included in an enabled sales-format type, triggers a search for promoted items that match a type, as specified in the promoted information fields. Promoted information fields are defined above.

FIG. 12 illustrates a keywords type association (KWTA) table 66. The KWTA table 66 is indexed by seller identification (USER_ID_{—}1, etc.). The seller configures a keyword type merchandising association by providing referring and promoted information.

The referring information includes an enable flag, “E”, and multiple keywords (keyword_{—}1 keyword_{—}2, etc.) Thus, configuration of keywords results in an asserted “E” flag and population of the keyword fields. Keyword fields are compared with the “title” and/or “description” and/or other text fields that are associated with the referring item of the potential buyer. Matching keywords result in a search for promoted items that match a type, as specified in the promoted information fields. Promoted information fields are defined above.

Methods

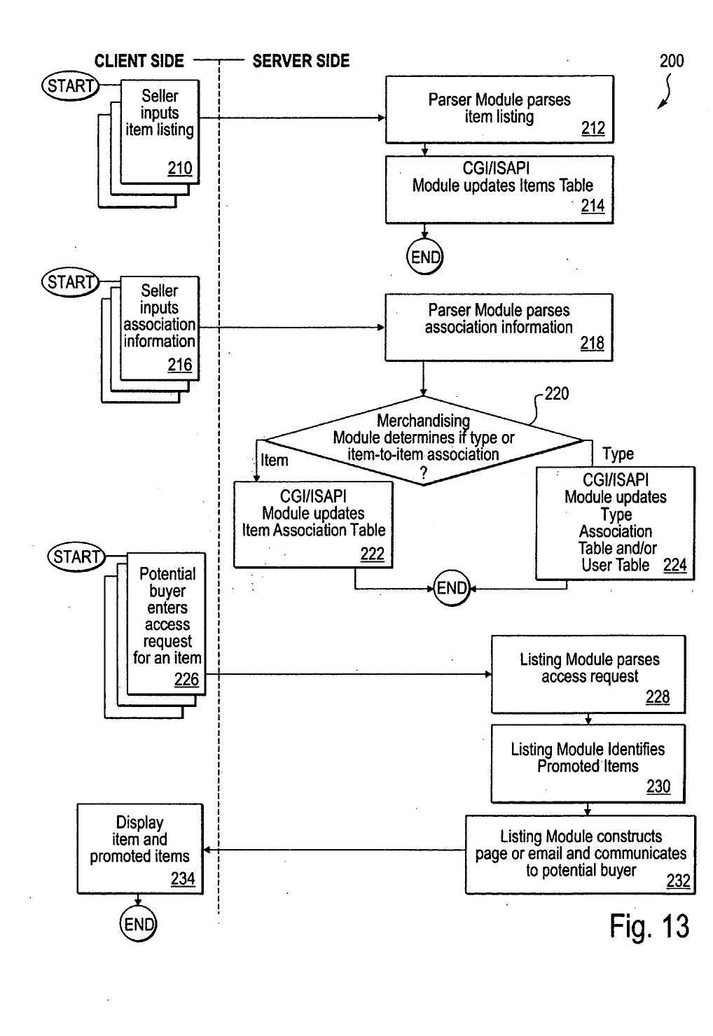

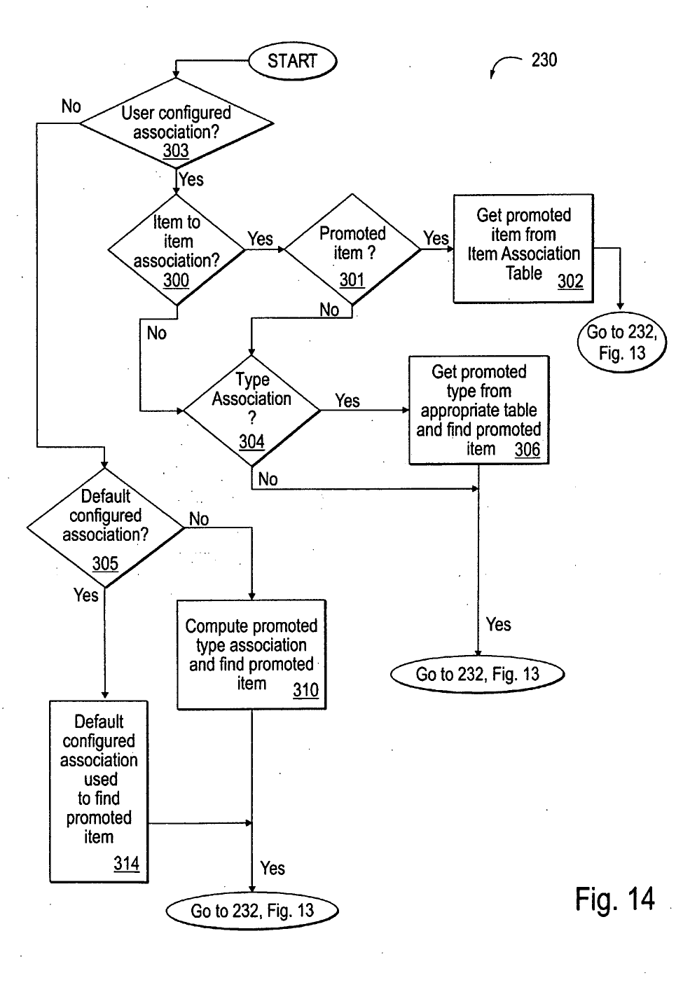

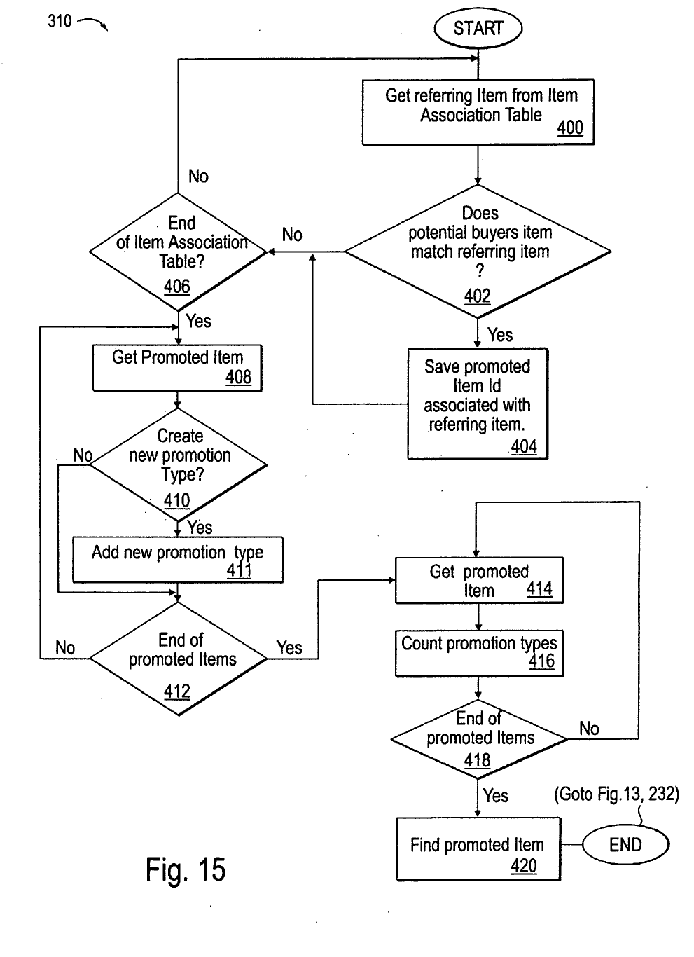

FIG. 13 is a flow chart illustrating a method 68, according to an exemplary embodiment of the present invention, to facilitate merchandising in a network-based marketplace 10. Client and server sides operations are illustrated with three client side starts.

At box 210, a seller, accessing the client machine 32, inputs an item listing that includes the item information. The item information may be embodied as a title, descriptive information, price, category, category-attributes, graphic image, sales-format, availability of gift-wrapping, availability of shipping destinations, regional availability, and other information types that would facilitate the transaction of a product or service as an item in the network-based marketplace 10. Item information identifies an item and is assigned a unique item identification number that is used to designate the item. The user concludes inputting the item information and transmits the item information to the network-based marketplace 10.

At box 212, the network-based marketplace 10 receives and extracts the item information from network messages with a parser module 170. The parser module 170 passes the item information to an CGI/ISAPI module 110.

At box 214, the CGI/ISAPI module 110 receives the item information and updates the items table 42 thus registering seller's item listing for transaction in the network-based marketplace 10.

At box 216, a seller, accessing the client machine 32, inputs exemplary association information in the exemplary form of “type” and “item” merchandising associations.

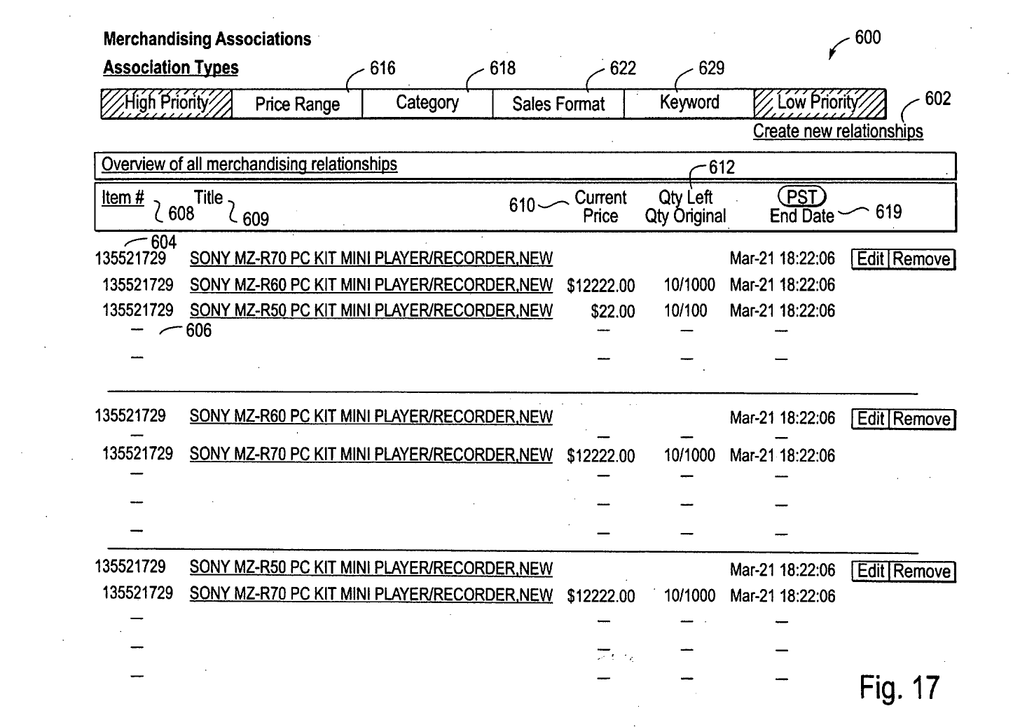

In an exemplary embodiment of the present invention, an item-to-item association enables a seller to associate a referring item with a promoted item. An item-to-item association is created, edited, removed, viewed, confirmed and deleted by a seller utilizing a user interface in the exemplary form of screens as illustrated by FIGS. 17-23, which may be rendered from descriptor language (e.g., HTML page).

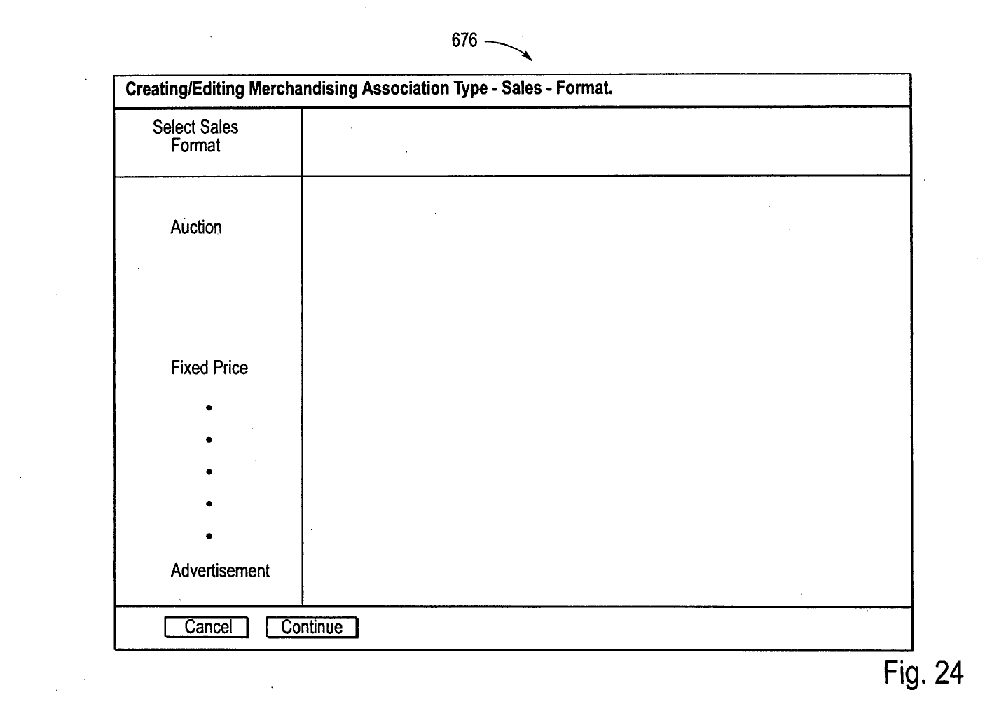

Type associations identify promoted items based upon characteristics that are shared between referring and promoted items. Type associations may, for example, include: Price-Range, Category, Category-Attributes, Sales-Format and Keyword. It will be appreciated that many other types could be added and illustrated types are merely a single embodiment. A seller may configure both a referring type and promoted type. A type-to-type association is created, edited, removed, and viewed by a seller utilizing a user interface in the exemplary form of screens as illustrated by FIGS. 24-29, which may be rendered from descriptor language (e.g., HTML page).

It will be appreciated that Type-to-Item and Item-to-Type merchandising associations, though not illustrated, may also embody the present invention. Thus, a potential buyer may request the item information for an item that is associated with a type-X. In this example, all other items offered by the same seller and included within type-X are candidate promoted items. Similarly, a potential buyer may request the item information for an item that is included in type-X. In this example, specific items offered by the same seller and associated with type-X are candidate promoted items.

At box 218, the network-based marketplace 10 receives and extracts the association information from network messages with the parser module 170. The parser module 170 passes the association information to the merchandising module 172.

At decision box 220, the merchandising module 172 determines if the seller has configured a type-to-type or item-to-item association. It will be appreciated that other types of associations may exist that are not described herein (e.g., item-to-type, type-to-item). The merchandising module 172 passes the association information to the CGI/ISAPI module 110.

At box 222, the CGI/ISAPI module 110 updates the item association table 42 with item-to-item association information and ends. Otherwise, at box 224, the CGI/ISAPI module 110 updates the appropriate type association table 64, 66, 68 or 70 with type-to-type association information and ends.

At box 226, an exemplary potential buyer, accessing the client machine 32, enters an exemplary access request for an item. Subsequently, the access request is transmitted to the network-based marketplace 10.

At box 228, the listing module 120 parses the access request for an item, the referring item, and extracts necessary information to identify promoted items.

At box 230, the listing module 120 uses the item id of the referring item to identify promoted items. A promoted item may be identified with an item-to-item association, type-to-type association, a computed association, or with a default association, as further described and illustrated in FIG. 14.

At box 232, the listing module 120 constructs the page, email or other form of communication (e.g., visual or audio) from referred and promoted item information. The listing module 120 transmits the communication to the client machine 32.

At box 234, the client communication program 30 (e.g., browser, email client, etc.) displays merchandising information as referring and promoted items. Merchandising information may be displayed responsive to an exemplary access request for referring the item information, received at the network-based marketplace 10 from a potential buyer. For example, one embodiment of an access request for referring item information may include buyer's confirmation as the current highest bidder for the referring item (FIG. 30). Another embodiment may include buyer's confirmation of a purchase or buyer's checkout. It will be appreciated that buyer's access request for referring item information may be embodied in any operation required to transact a referring item including but not limited to: inspection, bidding, purchasing, checkout, confirmation, requests for additional information, etc. Further, an exemplary presentation of merchandising information may be embodied in various forms including but not limited to a web page, email, multimedia presentation, voice communication or any network based means of communicating information to a potential buyer.

FIG. 14 is a flow chart illustrating a method, according to an exemplary embodiment of the present invention, for a listing module to identify promoted items in a network-based marketplace 10.

The method 230 commences at decision box 303 with the listing module 120 utilizing the item identification number of the item requested by the potential buyer to determine if the user has configured an association for the item. The listing module 120 determines that an item-to-item association has been configured by finding an entry for the requested item in the item association table 43. The listing module 120 branches to decision box 300 upon determining that an item-to-item association has been configured. Otherwise the listing module 120 determines if a type-to-type association has been configured by first indexing into the items table 32 with the item number of the item requested by the potential buyer and extracting the user identification number. Next, the listing module 120 looks for an enabled user entry in the default tables (64, 66, 68 and 70) based upon the requested item types. The listing module 120 branches to decision box 300 if a type-to-type association has been configured by the seller. Otherwise the listing module 120 branches to decision box 305.

At decision block 300, the listing module 120 indexes into the item association table 43 with the referring item identification number of the item requested by the potential buyer. The listing module 120 branches to box 301 if at least one referring item identification number is found in the item association table 43. Otherwise the listing module 120 branches to decision box 304.

At decision box 301, the listing module 120 examines association entries in the item association table 43 with a referring_item_id that match the referring item identification number. For each matching number, the position field is checked for spot_{—}1, spot_{—}2 or spot_{—}3, indicating the display position of the promoted item. Promoted items identified as alternate_{—}1 and alternate_{—}2 may be used to replace an ended or unoccupied spot position. The listing module 120 branches to box 302 upon finding three promoted items to occupy the respective spot positions. The listing module also branches to box 302 upon reaching the end of the item association table 43 and partial occupancy of spot positions; however, an alternate embodiment may branch to decision box 304 to fully occupy spot positions. The listing module 120 branches to decision box 304 upon reaching the end of the item association table 43 and determining that no promoted items exist for the referring_item_id.

At box 302, the listing module 120 gets promoted items id's from the item association table 43 and extracts listing information from the items table 42. Processing continues at box 232, FIG. 13.

At box 304, the listing module 120 determines type associations that are enabled by the seller for the referring item. The listing module 120 obtains the seller id from the items table 42 by indexing items table 42 with the referring item id. The listing module 120 utilizes the seller id for indexing into the user table 40 to extract referring type priorities. The listing module 120 starts with the highest priority referring type and finishes with the lowest priority referring type.

For each referring type, the listing module 120 reads the seller configured entry in the appropriate type table 64, 66, 68 and 30. Each type table includes a referring enable flag. An asserted referring enabled flag indicates a configured type association; however, the attribute type also requires an enabled category type.

For each referring enabled type, the listing module 120 compares the referring item to the referring enabled type to determine if the referring item is included in the referring enabled type. For example, if the toys category is enabled and the referring item is listed toy category, then the referring item is included in the referring enabled type thus triggering a search for promoted items in the seller defined promoted type. Keyword and attributes types require further tests to determine whether the referring item will trigger a search for a promoted item. A keyword type requires that keywords stored in the referring information fields of the keyword type association table 68 are also found in the referring items description or title. Other embodiments may include a keyword search in other types of item information. Further, an enabled attribute type requires that attributes stored in the referring information fields of the category type association table 64, match corresponding attributes of the referring item. For example, the seller may configure the category type association table 64 to specify the attribute “number of tickets” as two. Thus, the referring item must also specify the number of tickets as two before triggering a search for promoted items in the configured promoted type.

The listing module 120 branches to box 306 upon detecting one or more enabled type associations. Otherwise the listing module 120 branches to box 232, FIG. 13.

At box 306, the listing module 120 gets promoted types from the appropriate type association table and finds promoted items. The listing module 120 identifies a promoted type via a referring item that is included in an enabled referring type, as previously described. The listing module 120 characterizes a promoted type via promoted information as defined in the association tables 64, 66, 68 and 70. The listing module 120 reads a set of flags indicating a single promotion type per referring type; the set of flags including the following types: category, category-attributes, sales-format, price-range and keywords; however, other embodiments may include additional promoted types. The listing module 120 utilizes the promotion type to identify promoted items from sellers other items defined in the items table 42. The listing module 120 finds a promoted item upon determining that seller's item is included in an enabled seller defined type. After the listing module 120 identifies three promoted items, a branch is made to box 232 on FIG. 13. The listing module 120 also branches to box 232, FIG. 13 for incomplete or unsuccessful identification of promoted items; however, other embodiments may continue searching.

At decision box 305, the listing module 120 determines if the network-based marketplace 10 has a default configuration type association. An administrator of network-based marketplace 10 may configure a default type association in the same manner as a user. The listing module 120 branches to box 314 if a default configured association type has been configured. Otherwise the listing module 120 branches to box 310.

At box 310, the listing module 120 computes a default promotion type to search for promoted items. The listing module 120 branches to decision box 312 upon identifying three promoted items or upon exhaustion of users other items. See FIG. 15 for additional details.

At box 314, the listing module 120 branches to box 232, FIG. 13 upon identifying three promoted items or exhausting seller's items for the configured type. The listing module 120 identifies a promoted item by searching seller's items based on the default association type.

FIG. 15 is a flow chart illustrating a method 310 according to an exemplary embodiment of the present invention to identify a promoted item based on a computed or default promotion type. A default promotion type leverages the association information that has been configured by users of the network-based marketplace 10 to compute and apply the most commonly used association to the seller's other products. A default promotion type provides an advantage to an unsophisticated seller by providing the most commonly used merchandising association notwithstanding the seller's lack of merchandising experience. The present embodiment computes a default promotion type from item-to-item associations; however, it will be appreciated that a default promotion type may be computed from any type of seller configurable merchandising associations including item-to-item, type-to-type, item-type, type-item, etc.

At box 400, the listing module 120 invokes the examining module to read a referring item from the item association table 58. The item association table 58 includes item-to-item merchandising associations for sellers in the network-based electronic marketplace 10.

At decision box 402, the examining module branches to box 404 if the potential buyers item listing information matches the referring item's listing information. Various comparisons may be made based upon listing information (e.g., title, item description, price, category, category-attributes, sales-format, price-range, keywords, availability of gift wrapping, sellers profile information, color of item, region offered for transacting, shipping locations, title of item, etc) or type information (e.g., category, category-attribute, sales-format, price-range, keyword, etc). Different embodiments may require more or less precision with respect to identifying a match. The examining module branches to box 404 upon determining a match. Otherwise a branch is made to decision box 406.

At box 404, the examining module obtains the promoted item that is associated with the matching referring item by reading the promoted item from the item association table 58 and saving the promoted item identification number in a temporary work area.

At decision box 406, the examining module completes and the listing module 120 branches to box 408 upon determining the end to the item association table 58. Otherwise the examining module branches to box 400.

At box 408, the listing module 120 invokes the inferring module to get a promoted item that was previously saved in the temporary work area and branches to decision box 410.

At decision box 410, the inferring module determines if new promotion types should be created from the promoted item by comparing previously saved promotion types with the promoted types exhibited by the promoted item. Various types may be created based upon listing information (e.g., title, item description, price, category, category-attributes, sales-format, price-range, keywords, availability of gift wrapping, sellers profile information, color of item, region offered for transacting, shipping locations, title of item, etc) or type information (e.g., category, category-attribute, sales-format, price-range, keyword, etc). Different embodiments may expand or contract type definitions. The inferring module branches to box 411 upon determining that a new promotion type should be created. Otherwise the inferring module branches to decision box 412.

At box 411, the inferring module adds the new promotion type, identified in decision box 310, to the temporary work area.

At decision box 412, the inferring module branches to box 414 upon determining the end of promoted items in the temporary work area. Otherwise the inferring module branches to box 408.

At box 414, the inferring module gets a promoted item type from the temporary work area.

At box 416, for each type, the inferring module increments a type count upon determining that the promoted item is included in the type. Thus, the greatest type count signifies the most commonly used merchandising association type that is utilized by sellers.

At decision box 418, the inferring module branches to box 420 upon determining an end to promoted items in the work area. Otherwise, the inferring module branches to box 414.

At box 420 the inferring module uses the three highest ranked types (e.g., most counts) to identify promoted items; however, other embodiments may use more or less ranked types. The inferring module branches to decision box 232, FIG. 13 upon identifying three promoted items from seller's other items or upon exhausting seller's other items and not identifying three promoted items.

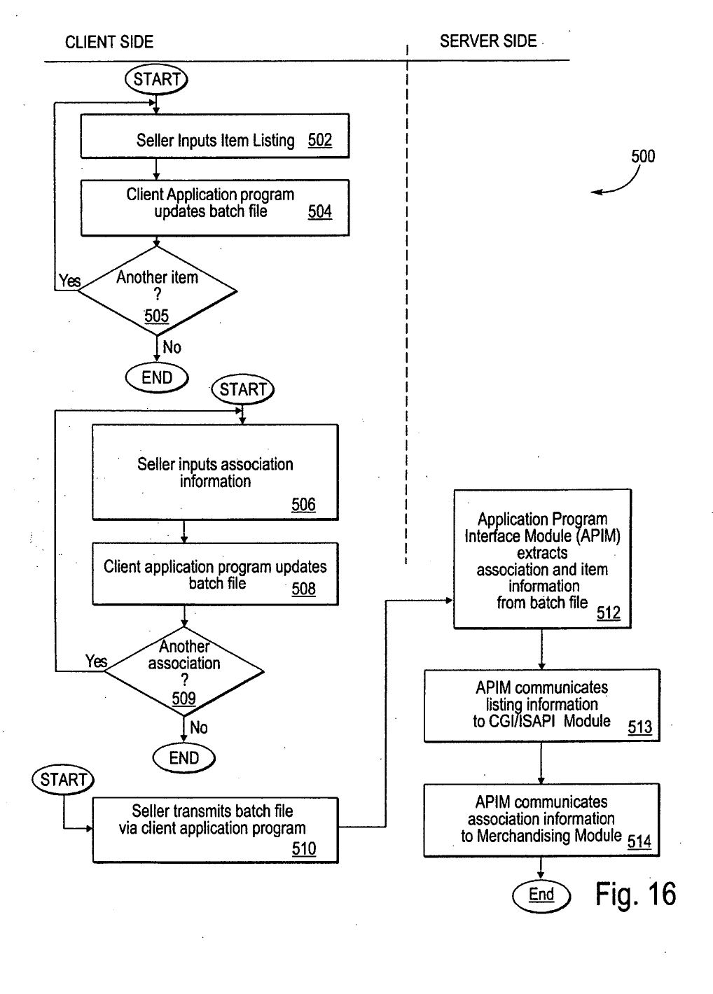

FIG. 16 is a flow chart illustrating a method 500, according to an exemplary embodiment of the present invention, to collect merchandising information for a network-based marketplace 10. Client processing is illustrated on the left and server processing is illustrated on the right. The method 500 enables a client to input large quantities of item listings and merchandising associations and reduce interactions with the network-based marketplace 10. The method 500 may be embodied as the client application program 33 executing on the client machine 32 or the mobile client machine 17.

At box 502, the seller inputs an item listing including the item information. Item information may be embodied as a title, descriptive information, price, category, category-attributes, graphic image, sales-format, availability of gift-wrapping, availability of shipping destinations, regional availability, and other information types that would facilitate the transaction of a product or service as an item in the network-based marketplace 10. The client application program 33 receives the item information via a user interface component 35. The user interface component 35 passes item information to a logic component 36.

At box 504, the logic component 36 of the client application program 33 updates a batch file in a storage component 37 with the item information.

At decision box 505, the logic component 36 of the client application program 33 ends upon determining that seller does not wish to enter another listing. Otherwise the logic component 36 branches to box 502.

At box 506, the seller inputs “type” and/or “item” association information, as previously described in this document. The client application program 33 receives the association information via a user interface component 35. The user interface component 35 passes association information to the logic component 36.

At box 508, the logic component 36 of the client application program 33 updates the batch file in the storage component 36 with association information.

At decision box 509, logic component 36 of the client application program 33 ends upon determining that seller does not wish to enter additional association information. Otherwise the client application program 33 branches to box 506.

At box 510, the seller transmits the batch file via the client application program 33. The user interface component 35 receives the request from the seller and invokes the logic component 36. The logic component 36 reads the batch file from the storage component 37 and communicates the batch file to the communications component 38. The communications component 38 communicates the batch file to an application interface (API) module 171.

At box 512, on the server side, the API module 171 receives the batch file and extracts the item information and the association information from the batch file.

At box 513, the API module 171 communicates the listing information to the CGI/ISAPI module 110. The CGI/ISAPI module 110 updates the item table 42 with the listing information.

At box 514, the API module 171 communicates the association information to the merchandising module 172. The merchandising module 172 updates the item association table 43 and/or the appropriate type tables 64, 66, 68 and 70 via the CGI/ISAPI module 110.

Screens

FIG. 17 illustrates an exemplary merchandising associations page 600. A merchandising association page 600 provides an overview of seller defined merchandising associations between items. An item-to-item merchandising association is created with the “Create new relationships” button 602 at right-hand top of the page. The body of the screen illustrates previously created associations. A single referring item 604 (e.g., identified with an item number furthest left) may be associated with up to five promoted items. Solid horizontal lines delimit distinct sets of one referring and five corresponding promoted items. The initial three promoted items are identified in other parts of this application as “spot 1”, “spot 2” and “spot 3”. An association may specify a promoted item that has ended (e.g., the item has ended after the association was configured). An ended item is illustrated as a dash 606 in place of that item's “Item#”, “Current Price”, “Qty Left,Qty Original” and “End Date” fields. The final two promoted items are identified in other parts of this application as “Alternate 1” and “Alternate 2”. Alternate promoted items replace ended spot items on merchandising screens. Further, the display of a referring item without a promoted item indicates that “type”, “computed” or “default” associations will be used to identify promoted items. Finally, an item that does not appear as a referring item on the screen will utilize the default association to identify promoted items.

Columns across the screen include: “Item #” column 608, “Title” column 609, “Current Price” column 610, “Qty Left Qty Original” column 612 and “End Date” column 619. The “Item #” column 608 specifies the item identification number. The “Title” column 609 specifies the seller provided title for the item. The “Current Price” column 610 specifies the current asking or bidding price for the item. The “Qty Left Qty Original” column 612 specifies the number of items remaining from the number of initial items offered. The “End Date” column 619 specifies the date and time all transacting is concluded for the item.

Association types are located at the top of the screen. Association types are arranged from highest to lowest priority, left to right. The priority of an association type may be changed with a click and drag operation. For instance, dragging an association type from left to right will lower the priority of an association type. Clicking on an association type permits configuration of that type and requires configuration of the referring item type and the promoted item type. Exemplary association types include but are not limited to: price-range 616, category 618, category-attribute, sales-format 622, and keyword 629.

Configuring a referring type is performed by first selecting the referring type from the merchandising association page 600. Configuring the referring type is performed with the Creating/Editing Merchandising Association Type screen for the respective type (FIGS. 24-28). Next, the promoting type is selected via the Creating/Editing Merchandising Association Type—Select Association Promotion Type (FIG. 29). Configuring a promoted type is performed in the same manner as configuring referring types (e.g. with the Creating/Editing Merchandising Association Type screens previously described; FIGS. 24-28).

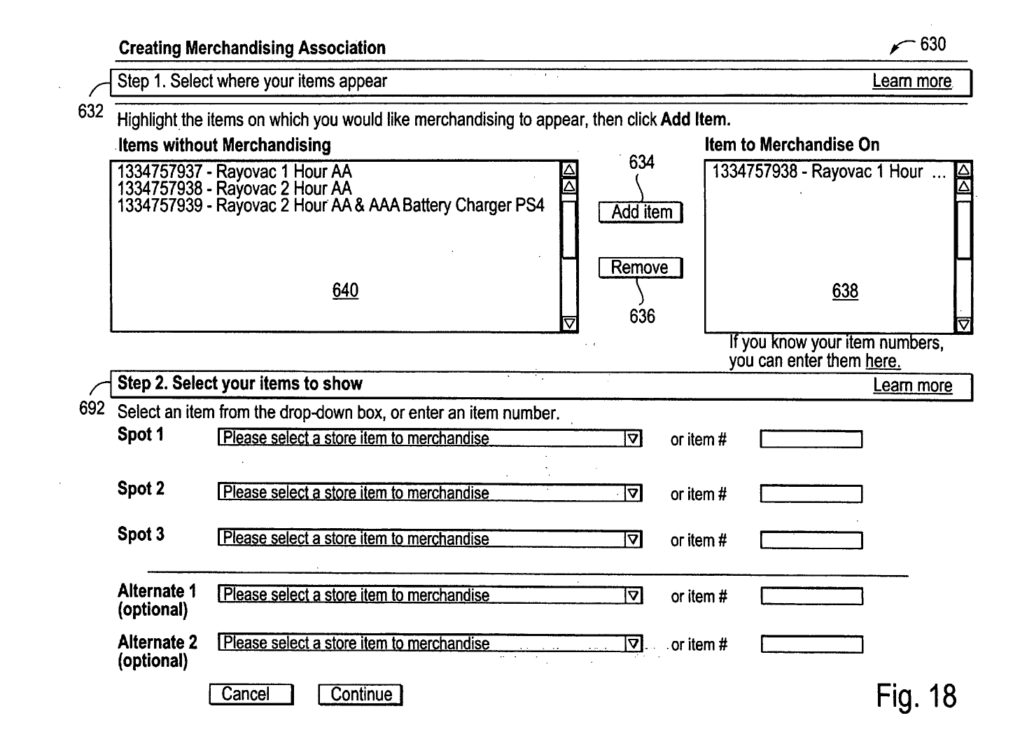

FIG. 18 illustrates an exemplary creating merchandising association page 630 according to an embodiment of the present invention. A seller may use this page 630 to associate multiple referring items to a single set of promoted items. “Step 1” 632 identifies items to merchandise on. Items are added and removed with the “add item” and “Remove” buttons 634 and 636 respectively. Added items appear in the right hand box 638 under the caption “Item to Merchandise On”. Further, a seller may manually enter item numbers in the “Item to Merchandise On” box 638. Items without a merchandising association with respect to the displayed set of promoted items appear in the left hand box 640 under the caption “Items without Merchandising”.

“Step 2” 642 identifies items to promote. Promoted items are added and removed with drop-down menus or by entering an item number. A promoted item may be entered in the position of “Spot 1” or “Spot 2” or “Spot 3” or “Alternate 1” or “Alternate 2”. Alternate positions are optional.

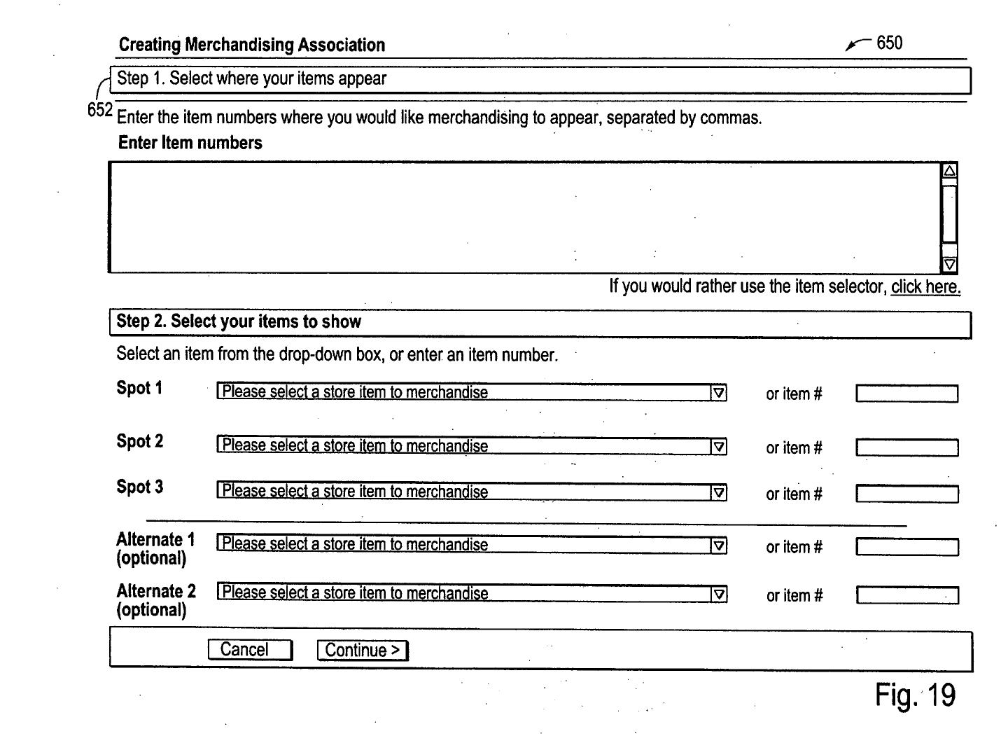

FIG. 19 illustrates an alternate embodiment of a creating merchandising association page 650. “Step 1” 652 identifies items to merchandise on. A seller adds an item by entering the item number in the “Enter Item numbers ” box. “Step 2” operates as described in FIG. 18.

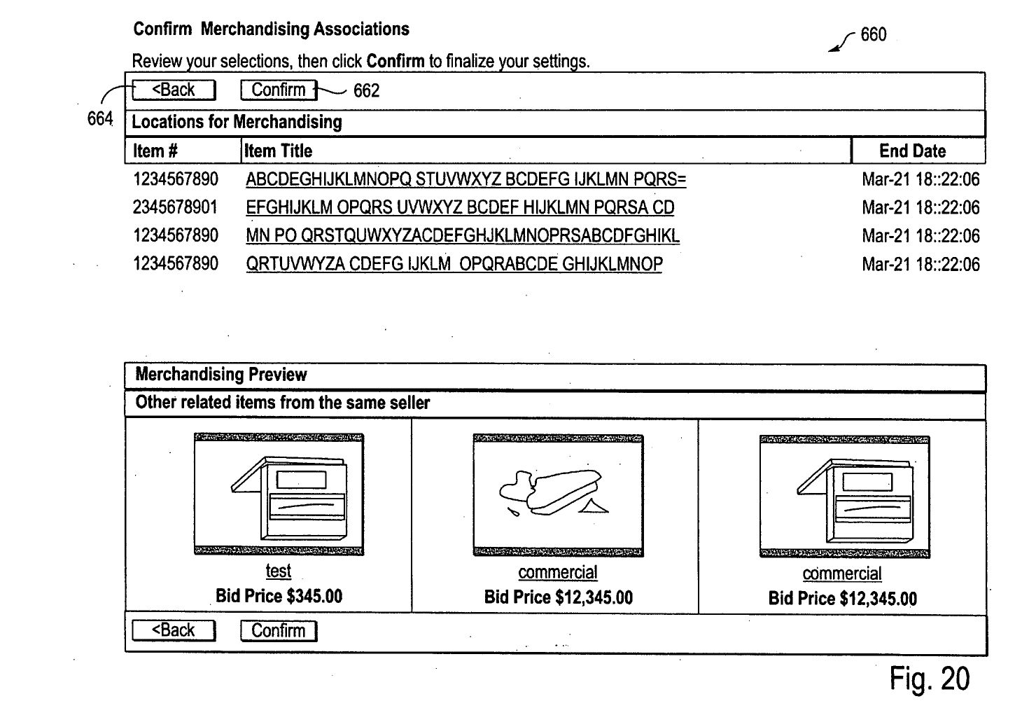

FIG. 20 illustrates an exemplary embodiment confirm merchandising association page 660 according to an embodiment of the present invention. This page 660 provides the seller with an opportunity to finalize new associations. A confirm button 602 registers the new item associations. Otherwise a back button 664 discards the item associations.

Other pages, not illustrated, may be utilized to maintain association information. An edit merchandising association page may be used to edit and present information as previously described. A confirm merchandising association page may provide the seller with an opportunity to confirm edits and emphasizing the differences between old and new merchandising associations. A delete merchandising associations page deletes all item and default associations for a referring item.

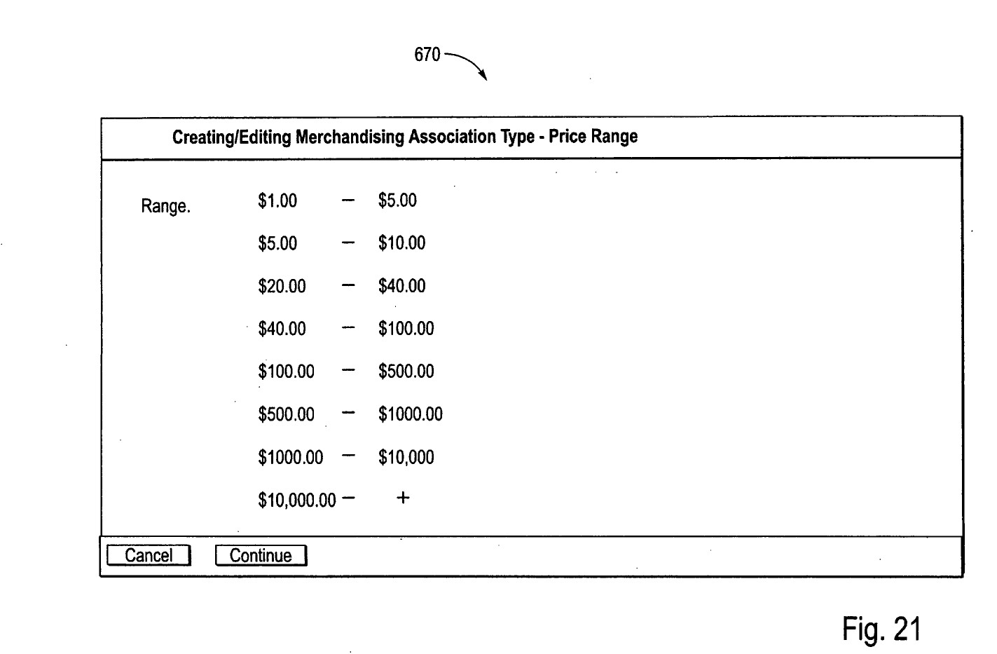

FIG. 21 illustrates an exemplary embodiment of a creating/editing merchandising association type—price-range page 670 according to one embodiment of the present invention. This page 670 is used to enable a price-range for referring and promoted types.

FIG. 22 illustrates an exemplary embodiment of a creating/editing merchandising association type—categories and category-attributes page 672 according to one embodiment of the present invention. This page 672 is used to enable a category and/or enable (on) category attributes for referring and promoted types.

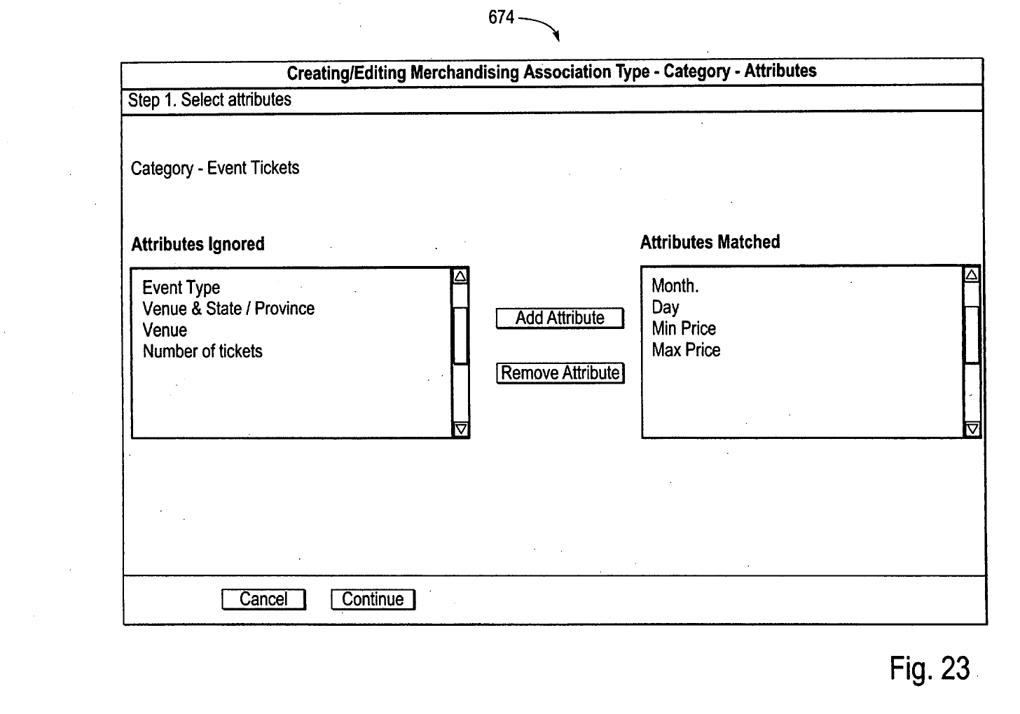

FIG. 23 illustrates an exemplary embodiment of a creating/editing merchandising association type—category-attributes page 674 according to one embodiment of the present invention. This page is used to enable category attributes for referring and promoted types.

FIG. 24 illustrates an exemplary embodiment of a creating/editing merchandising association type—sales-format page 676 according to one embodiment of the present invention. This page 676 is used to enable a sales-format for referring and promoted types.

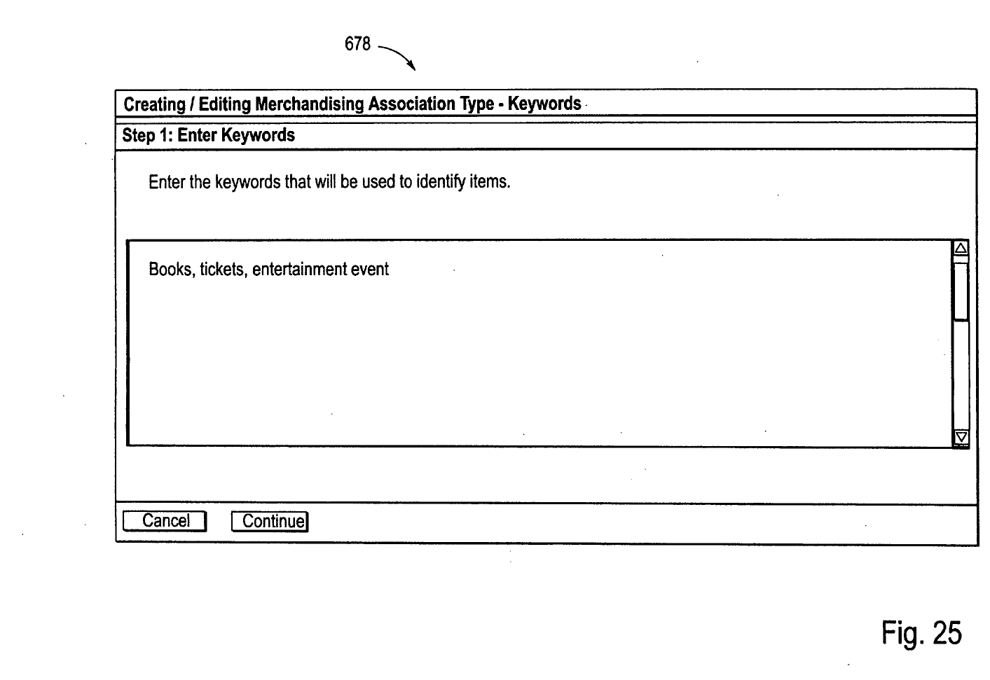

FIG. 25 illustrates an exemplary embodiment of a creating/editing merchandising association type—keywords page 678 according to one embodiment of the present invention. This page 678 is used to enable keywords and enter keywords for referring and promoted types.

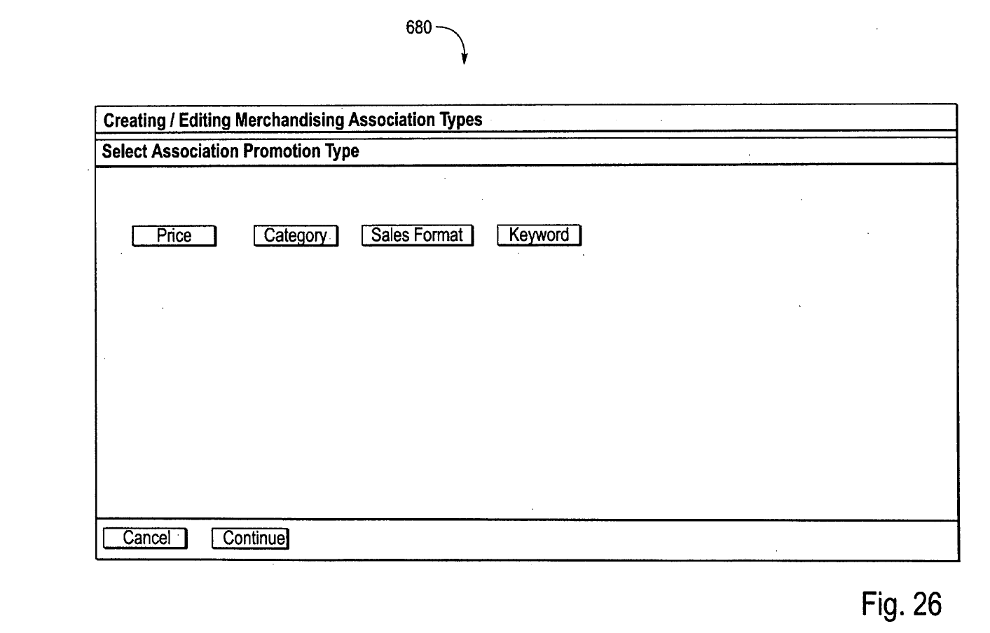

FIG. 26 illustrates an exemplary embodiment of a creating/editing merchandising association—select association promotion type page 680 according to one embodiment of the present invention. This page 680 is used to select a promotion type.

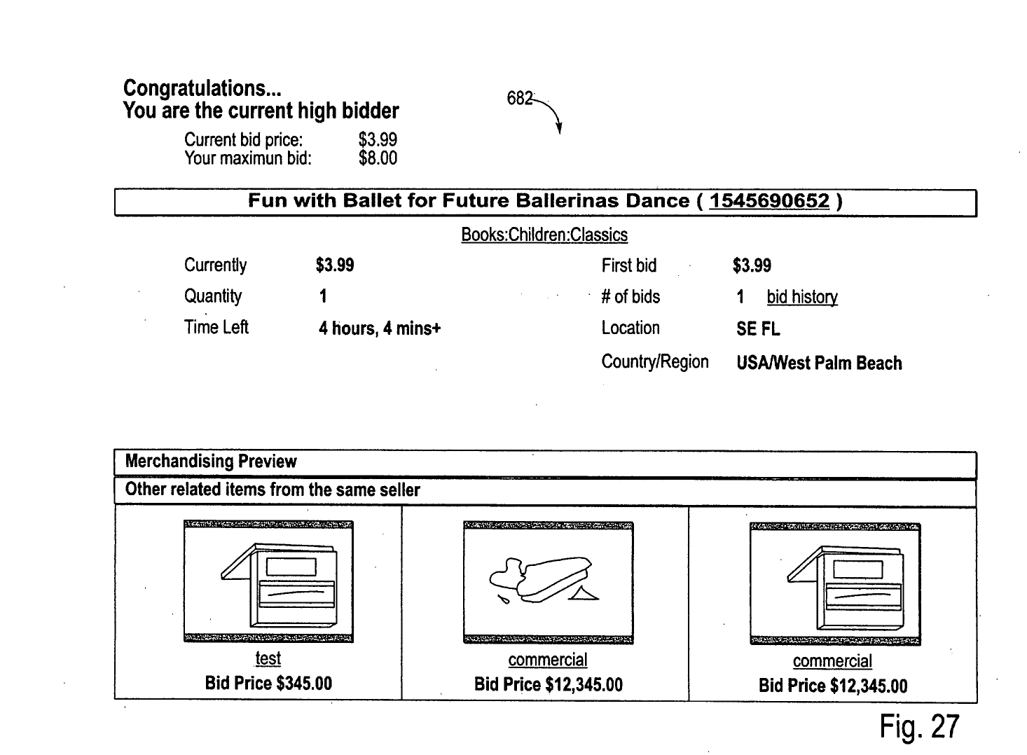

FIG. 27 illustrates an exemplary embodiment of a presentation of merchandised items in the form of a current highest bidder page 682 according to one embodiment of the present invention. A bidder has made the highest bid for an item. The page 682 displays item information for the highest bidded item and associated promoted items. It will be appreciated that the presentation of merchandising items may also be embodied in response to other events (e.g, request for information, checkout, negotiation, etc.) or in other forms (e.g, email, fax, etc.).

Computer System

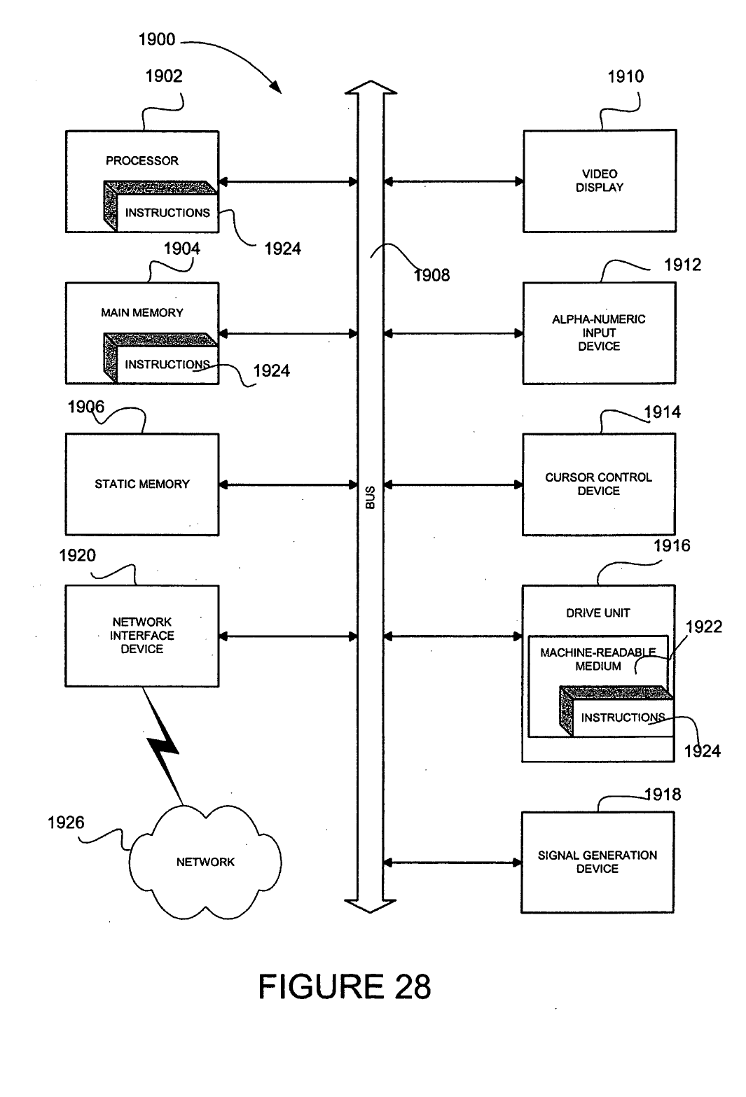

FIG. 28 shows a diagrammatic representation of machine in the exemplary form of a computer system 1900 within which a set of instructions, for causing the machine to perform any one or more of the methodologies discussed herein, may be executed. In alternative embodiments, the machine operate as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 1900 includes a processor 1902 (e.g., a central processing unit (CPU) a graphics processing unit (GPU) or both), a main memory 1904 and a static memory 1906, which communicate with each other via a bus 1908. The computer system 1900 may further include a video display unit 1910 (e.g., a liquid crystal display (LCD) or a cathode ray tube (CRT)). The computer system 1900 also includes an alpha-numeric input device 1912 (e.g., a keyboard), a cursor control device 1914 (e.g., a mouse), a disk drive unit 1916, a signal generation device 1918 (e.g., a speaker) and a network interface device 1920.

The disk drive unit 1916 includes a machine-readable medium 1922 on which is stored one or more sets of instructions (e.g., software 1924) embodying any one or more of the methodologies or functions described herein. The software 1924 may also reside, completely or at least partially, within the main memory 1904 and/or within the processor 1902 during execution thereof by the computer system 1900, the main memory 1904 and the processor 1902 also constituting machine-readable media.

The software 1924 may further be transmitted or received over a network 1926 via the network interface device 1920.

While the machine-readable medium 1992 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to included, but not be limited to, solid-state memories, optical and magnetic media, and carrier wave signals.

Thus, a method and a system for facilitating merchandising in a network-based marketplace has been described. Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

1. A method to facilitate merchandising in a network-based marketplace, the method including:
receiving item listings at the network-based marketplace from a plurality of sellers, each item listing including item information identifying an item to be transacted via the network-based marketplace;
receiving association information at the network-based marketplace from a first seller of the plurality of sellers, the association information including a first item identifier that identifies a first item, a second item identifier that identifies a second item and a merchandising association between the first item and the second item, the first and second items each being associated with the first seller; and
responsive to an access request, received at the network-based marketplace from a potential buyer, for the item information identifying the first item, presenting the item information for the first item and the second item wherein the second item is identified using the association information and wherein the item information identifying the second item is presented for the purpose of merchandising the second item.

2. The method of claim 1 wherein association information is generated by a seller at a client machine.

3. The method of claim 1 wherein the access request is generated by the potential buyer from a client machine.

4. The method of claim 1 wherein item information identifying the second item includes a graphic image.

5. The method of claim 1 wherein item information for the second item includes at least one of a group including descriptive information, a category, at least one of a plurality of attributes, a price, and a sales-format.

6-10. (Canceled)

11. The method of claim 1 wherein the access request received at the network-based marketplace from the potential buyer is for the item information identifying the first item.

12. The method of claim 1 wherein the access request received at the network-based marketplace from the potential buyer is to facilitate transacting with respect to the first item.

13. The method of claim 1 wherein item information is presented as a descriptor language page.

14. The method of claim 1 wherein item information is presented as an email.

15. The method of claim 14 wherein the second item is a primary promoted item.

16. The method of claim 15 wherein the second item is a secondary promoted item that has replaced the primary promoted item.

17. A method to facilitate collection of merchandising information for a network-based marketplace, the method including:
at a seller computer, receiving item listings, each item listing including item information identifying an item to be transacted via the network-based marketplace;
at the seller computer, receiving association information that includes a first item identifier that identifies a first item, a second item identifier that identifies a second item and a merchandising association between the first item and the second item, the first and second items each being associated with a seller;
at the seller computer, storing the association information indicating the merchandising association in a batch file; and
at the seller computer, transmitting the batch file to an application program interface at the network-based marketplace so as to enable the network-based marketplace to store the merchandising association between the first and second items.

18. The method of claim 17 wherein the network-based marketplace responds to an access request received at the network-based marketplace from a potential buyer for the item information identifying the first item, by presenting the item information for the first item and the second item wherein the second item is identified using the association information and wherein the item information identifying the second item is presented for the purpose of merchandising the second item.

19. The method of claim 18 wherein the merchandising association is between a plurality of first items and a plurality of second items.

20. The method of claim 18 wherein the network-based marketplace supports a plurality of buyers and includes a plurality of item listings.

21. A method of automatically creating merchandising associations between items in a network based marketplace the method including:
examining a first merchandising association defined by a first user seller of a network based marketplace;
inferring a second merchandising association to be applied to items for sale by a second seller based on the first merchandising association.

22. A system to facilitate merchandising in a network-based marketplace, the system including:
a parser module for receiving item listings at the network-based marketplace from a plurality of sellers, each item listing including item information identifying an item to be transacted via the network-based marketplace;
a merchandising module for receiving association information at the network-based marketplace from a first seller of the plurality of sellers the association information including a first item identifier that identifies a first item, a second item identifier that identifies a second item and a merchandising association between the first item and the second item, the first and second items each being associated with the first seller; and
a listing module to respond to an access request, received at the network-based marketplace from a potential buyer, for the item information identifying the first item, by presenting the item information for the first item and the second item wherein the second item is identified using the association information and wherein the item information identifying the second item is presented for the purpose of merchandising the second item.

23. The system of claim 22 wherein the first and second items are purchased in a single transaction as a multi-item order.

24. The system of claim 22 wherein the merchandising association is between the first item and a plurality of second items.

25. A client application program to facilitate the collection of merchandising information for a network-based marketplace, the client application program including:
a user interface component to receive item listings, each item listing including item information identifying an item to be transacted via the network-based marketplace and to receive association information that includes a first item identifier that identifies a first item, a second item identifier that identifies a second item and a merchandising association between the first item and the second item, the first and second items each being associated with a seller;
a logic component to receive the item information and the association information from the user interface component, to store the item information and the association information in a batch file in a storage component, and upon request by the user, to read the batch file from the storage component for the purpose of transmitting the batch file; and
a communications component to receive the batch file from the logic component and to transmit the batch file to an application program interface at the network-based marketplace so as to enable the network-based marketplace to store the item information and the association information.

26. The client application program of claim 25 wherein the batch file transmitted to the application program interface at the network-based marketplace is utilized to respond to an access request received at the network-based marketplace from a potential buyer for the item information identifying the first item, the network-based marketplace presenting the item information for the first item and the second item wherein the second item is identified using the association information and wherein the item information identifying the second item is presented for the purpose of merchandising the second item.

27. A merchandising module for automatically creating merchandising associations between items in a network-based marketplace, the merchandising module including:
an examining module to examine a first merchandising association defined by a seller;
an inferring module to infer a second merchandising association to be applied to items for sale by a second seller based on the first merchandising association.

28. A system to facilitate merchandising in a network-based marketplace, the method including:
a first means for receiving item listings at the network-based marketplace from a plurality of sellers, each item listing including item information identifying an item to be transacted via the network-based marketplace;
a second means for receiving association information at the network-based marketplace from a first seller of the plurality of sellers, the association information including a first item identifier that identifies a first item, a second item identifier that identifies a second item and a merchandising association between the first item and the second item, the first and second items each being associated with the first seller; and
a third means for responding to an access request, received at the network-based marketplace from a potential buyer, for the item information identifying the first item, by presenting the item information for the first item and the second item wherein the second item is identified using the association information and wherein the item information identifying the second item is presented for the purpose of merchandising the second item.

29. A machine readable medium storing a set of instructions that, when executed by the machine, cause the machine to:
receive item listings at a network-based marketplace from a plurality of sellers, each item listing including item information identifying an item to be transacted via the network-based marketplace;
receive association information at the network-based marketplace from a first seller of the plurality of sellers, the association information including a first item identifier that identifies a first item, a second item identifier that identifies a second item and a merchandising association between the first item and the second item, the first and second items each being associated with the first seller; and
respond to an access request, received at the network-based marketplace from a potential buyer, for the item information identifying the first item, by presenting the item information for the first item and the second item, wherein the second item is identified using the association information and wherein the item information identifying the second item is presented for the purpose of merchandising the second item.

30. A machine readable medium storing a set of instructions that, when executed by the machine, cause the machine to:
at a seller computer, receive item listings, each item listing including item information identifying an item to be transacted Via a network-based marketplace;
at the seller computer, receive association information, the association information including a first item identifier that identifies a first item, a second item identifier that identifies a second item and a merchandising association between the first item and the second item, the first and second items each being associated with a seller;
at the seller computer, storing the association information indicating the merchandising association in a batch file; and
from the seller computer, transmitting the batch file to an application program interface at the network-based marketplace so as to enable the network-based marketplace to store the merchandising association between the first and second items.

31. A method to facilitate merchandising in a network-based marketplace, the method including:
receiving item listings at the network-based marketplace from a plurality of sellers, each item listing including item information identifying an item to be transacted via the network-based marketplace;
receiving association information at the network-based marketplace from a first seller of the plurality of sellers, indicating a merchandising association between a first item and a second item, the first and second items each being associated with the first seller; and
responsive to an access request, received at the network-based marketplace from a potential buyer, for the item information identifying the first item, presenting the item information for the first item and the second item wherein the second item is identified using the association information and wherein the item information identifying the second item is presented for the purpose of merchandising the second item wherein the merchandising association is a type-to-type association that is a price-range.

32. The method of claim 31 wherein the type-to-type association is at least one of a group of types including, a sales-format, a keyword, and an attribute.

33. A method to facilitate collection of merchandising information for a network-based marketplace, the method including:
at a seller computer, receiving item listings, each item listing including item information identifying an item to be transacted via the network-based marketplace;
at the seller computer, receiving association information indicating a merchandising association between a first item and a second item, the first and second items each being associated with a seller;
at the seller computer, storing the association information indicating the merchandising association in a batch file; and
at the seller computer, transmitting the batch file to an application program interface at the network-based marketplace so as to enable the network-based marketplace to store the merchandising association between the first and second items, wherein the merchandising association is a type-to-type association that is a price-range.

34. The method of claim 33 wherein the type-to-type association is at least one of a group of types including, a sales-format, a keyword, and an attribute.

35. A system to facilitate merchandising in a network-based marketplace, the system including:
a parser module for receiving item listings at the network-based marketplace from a plurality of sellers, each item listing including item information identifying an item to be transacted via the network-based marketplace;
a merchandising module for receiving association information at the network-based marketplace from a first seller of the plurality of sellers indicating a merchandising association between a first item and a second item, the first and second items each being associated with the first seller; and
a listing module to respond to an access request, received at the network-based marketplace from a potential buyer, for the item information identifying the first item, by presenting the item information for the first item and the second item wherein the second item is identified using the association information and wherein the item information identifying the second item is presented for the purpose of merchandising the second item wherein the merchandising association is a type-to-type association that is a price-range.

36. The method of claim 35, wherein the type-to-type association is at least one of a group of types including, a sales-format, a keyword, and an attribute.

37. A client application program to facilitate the collection of merchandising information for a network-based marketplace, the client application program including:
a user interface component to receive item listings, each item listing including item information identifying an item to be transacted via the network-based marketplace and to receive association information indicating a merchandising association between a first item and a second item, the first and second items each being associated with a seller;
a logic component to receive the item information and the association information from the user interface component, to store the item information and the association information in a batch file in a storage component, and upon request by the user, to read the batch file from the storage component for the purpose of transmitting the batch file; and
a communications component to receive the batch file from the logic component and to transmit the batch file to an application program interface at the network-based marketplace so as to enable the network-based marketplace to store the item information and the association information wherein the merchandising association is a type-to-type association that is a price-range.

38. The method of claim 37, wherein the type-to-type association is at least one of a group of types including, a sales-format, a keyword, and an attribute.

39. A machine readable medium storing a set of instructions that, when executed by the machine, cause the machine to:
receive item listings at the network-based marketplace from a plurality of sellers, each item listing to include item information to identify an item to be transacted via the network-based marketplace;
receive association information at the network-based marketplace from a first seller of the plurality of sellers, to indicate a merchandising association between a first item and a second item, the first and second items each associated with the first seller; and
responsive to an access request, received at the network-based marketplace from a potential buyer for the item information that identifies the first item, present the item information for the first item and the second item wherein the second item is identified with the association information and wherein the item information to identify the second item is presented to merchandise the second item wherein the merchandising association is a type-to-type association that is a price-range.

40. A machine readable medium storing a set of instructions that, when executed by the machine, cause the machine to:
at a seller computer, receive item listings, each item listing to include item information to identify an item to be transacted via the network-based marketplace;
at the seller computer, receive association information to indicate a merchandising association between a first item and a second item, the first and second items each associated with a seller;
at the seller computer, store the association information to indicate the merchandising association in a batch file; and
at the seller computer, transmit the batch file to an application program interface at the network-based marketplace so as to enable the network-based marketplace to store the merchandising association between the first and second items, wherein the merchandising association is a type-to-type association that is a price-range.
